(19) United States
(12) Patent Application Publication
(10) Pub. No.: US 2022/0166598 A1
(43) Pub. Date: May 26, 2022

(54) TRANSMISSION APPARATUS, RECEPTION APPARATUS, AND TRANSMISSION SYSTEM

(71) Applicant: SONY SEMICONDUCTOR SOLUTIONS CORPORATION, KANAGAWA (JP)

(72) Inventor: TAKANORI SAEKI, KANAGAWA (JP)

(21) Appl. No.: 17/440,931

(22) PCT Filed: Jan. 23, 2020
(86) PCT No.: PCT/JP2020/002291

§ 371 Date: Sep. 20, 2021

(30) Foreign Application Priority Data
Mar. 29, 2019 (JP) 2019-069105

(51) Int. Cl. H04L 7/00; H04N 1/00

(52) U.S. Cl. CPC H04L 7/0037; H04L 7/0008; H04N 1/0001; H04L 7/0066; H04N 1/00005; H04L 7/0087

(57) ABSTRACT

To provide a transmission apparatus, a reception apparatus, and a transmission system that operate at the same clock as the reception apparatus without mounting an oscillation circuit on the transmission apparatus and realize a low error rate.

A transmission apparatus includes a first reception circuit, and a first transmission circuit, in which the first reception circuit receives a clock from the reception apparatus, and the first transmission circuit synchronizes retention data retained by the first transmission circuit using the received clock, and transmits the retention data to the reception apparatus.

### TECHNICAL FIELD

The present technology relates to a transmission apparatus, a reception apparatus, and a transmission system.

### BACKGROUND ART

Conventionally, a transmission system for transmitting image data has been known. The transmission system has a transmission apparatus that transmits image data and a reception apparatus that receives the transmitted image data.

Each of the transmission apparatus and reception apparatus is mounted with a phase locked loop (PLL), and the mounted PLL drives each internal circuit to transmit and receive image data.

Here, in the conventional high-speed serial interface, in a case of a source synchronous system, data and clocks are transmitted in the same direction. In addition, in the case of clock embedded, the clock is superimposed on the data and transmitted.

In recent years, with the increase in the capacity of transmission data, various efforts have been made in s transmission system to increase a transmission speed of an interface that transmits image data to a signal processing large scale integrated circuit (LSI) (for example, see Patent Document 1)

### CITATION LIST

### Patent Document

Patent Document 1: Japanese Patent No. 5761551

### SUMMARY OF THE INVENTION

### Problems to be Solved by the Invention

In the conventional high-speed serial interface, an oscillation circuit is mounted on a transmission apparatus side, and a reference clock is supplied from a crystal oscillator, a PLL, or the like. However, an oscillation circuit on the transmission apparatus side requires a certain area for arrangement, which leads to an increase in the size of the transmission apparatus.

In addition, since the transmission apparatus and the reception apparatus operate at different clocks, it is considered that a random jitter component becomes large and an error rate becomes high.

The present technology has been made in view of the circumstances, and a main object of the present technology is to provide a transmission apparatus, a reception apparatus, and a transmission system in which a transmission apparatus operates at the same clock as a reception apparatus without mounting an oscillation circuit and realizes a low error rate.

### Solutions to Problems

As a result of intensive research to solve the above-described object, the present inventor has succeeded in realizing a low error rate by operating the transmission apparatus at the same clock as the reception apparatus without mounting an oscillation circuit, and has completed the present technology.

That is, first, the present technology provides a transmission apparatus including a first reception circuit,

a first transmission circuit,

in which the first reception circuit receives a clock from the reception apparatus, and

the first transmission circuit synchronizes retention data retained by the first transmission circuit using the received clock, and transmits the retention data to the reception apparatus.

The transmission apparatus according to the present technology may include an internal circuit, and

at least one of the first transmission circuit or the internal circuit may be driven without changing an operation frequency of the received clock.

In the transmission apparatus according to the present technology, the first transmission circuit may include

a first conversion unit,

a correction coding calculation unit,

a division unit, and

a transmitting unit,

the transmitting unit may include a plurality of transmission processing units,

the first conversion unit may convert the retention data into units constituting a predetermined symbol and output each unit,

the correction coding calculation unit may calculate an error correction code in the data for each of the plurality of units,

the division unit may divide a code word obtained by adding the error correction code to the data of each of the plurality of units into encoded data, and allocate the divided encoded data by a predetermined number so that the plurality of encoded data has the same amount of data in each of a plurality of transmission paths, and

each of the plurality of transmission processing units may packetize the allocated data of the same amount of data and transmit the packetized data to the reception apparatus via the plurality of allocated transmission paths using the received clock.

The transmission apparatus according to the present technology may include a signal processing unit,

the signal processing unit may use the received clock to perform addition processing on the retention data, and

the first conversion unit may convert the data subjected to the addition processing into the units constituting the predetermined symbol.

In the transmission apparatus according to the present technology, the retention data may be image data, or the transmission apparatus may further include an imaging unit, and the retention data may be a captured image captured by the imaging unit.

In the transmission apparatus according to the present technology, the first reception circuit may receive a single-phase clock or a differential clock, or a signal of either a single-phase signal or a differential signal in which external data transmitted from an external apparatus and a clock transmitted from the reception apparatus are superimposed.

The transmission apparatus according to the present technology may include a filter, and the filter may separate the clock transmitted from the reception apparatus from the signal in which the external data transmitted from the external apparatus and the clock transmitted from the reception apparatus are superimposed.

In the transmission apparatus according to the present technology, the signal in which the external data transmitted from the external apparatus and the clock transmitted from the reception apparatus are superimposed, or the external data transmitted from the external apparatus, the clock transmitted from the reception apparatus, and the retention data may be superimposed.

The transmission apparatus according to the present technology may further include a first transmission pattern cancel filter,

in which the first transmission pattern cancel filter may include a first mixer, and

the first mixer may mix the differential signal of the retention data with the signal in which the external data transmitted from the external apparatus, the clock transmitted from the reception apparatus, and the retention data are superimposed, cancel a waveform of the retention data from the signal in which the external data transmitted from the external apparatus, the clock transmitted from the reception apparatus, and the retention data are superimposed to separate the clock transmitted from the reception apparatus and the external data.

The transmission apparatus according to the present technology may further include a first transmission pattern cancel filter,

in which the first transmission pattern cancel filter may include

a first inverse pattern generation unit,

a first mixer,

the first inverse pattern generation unit may generate a first inverse pattern having a waveform opposite to the waveform of the retention data, and

The first mixer may mix the generated waveform of the first inverse pattern with the signal in which the external data transmitted from the external apparatus, the clock transmitted from the reception apparatus, and the retention data are superimposed, cancel the waveform of the retention data from the signal in which the external data transmitted from the external apparatus, the clock transmitted from the reception apparatus, and the retention data are superimposed to separate the clock transmitted from the reception apparatus and the external data.

In the transmission apparatus according to the present technology, the external data transmitted from the external apparatus, the clock transmitted from the reception apparatus, and the retention data may be superimposed, and at least one of the external data, the clock, and the retention data may be differentiated.

In the transmission apparatus according to the present technology, a single-phase clock may be received, and

the external data transmitted from the external apparatus and the retention data may be superimposed.

In addition, a reception apparatus includes a second transmission circuit and a second reception circuit,

in which the second transmission circuit transmits a clock to a transmission apparatus, and

the second reception circuit receives retention data retained by the transmission apparatus.

In the reception apparatus according to the present technology, the second transmission circuit may transmit a single-phase clock or a differential clock.

The reception apparatus according to the present technology may further include a second transmission pattern cancel filter,

in which the second transmission pattern cancel filter may include a second mixer, and

the second mixer may mix a differential signal of a waveform of external data and a differential signal of a clock transmitted from the reception apparatus with a signal in which the external data transmitted from the external apparatus, the clock transmitted from the reception apparatus, and the retention data are superimposed, and cancel the waveform of the external data and a waveform of the clock of the reception apparatus from the signal in which the external data transmitted from the external apparatus, the clock transmitted from the reception apparatus, and the retention data are superimposed to separate the retention data.

The reception apparatus according to the present technology may further include a second transmission pattern cancel filter,

in which the second transmission pattern cancel filter may include

a second inverse pattern generation unit, and

a second mixer,

the second inverse pattern generation unit may generate a second inverse pattern having a waveform opposite to the waveform of the external data and a third inverse pattern having waveform opposite to the waveform of the clock transmitted from the reception apparatus, and

the second mixer may mix the waveform of the second inverse pattern and the waveform of the third inverse pattern with the signal in which the external data transmitted from an external apparatus, the clock transmitted from the reception apparatus, and the retention data are superimposed, cancel the waveform of the external data and the waveform of the clock transmitted from the reception apparatus from the signal in which the external data transmitted from the external apparatus, the clock transmitted from the reception apparatus, and the retention data are superimposed to separate the retention data.

In the reception apparatus according to the present technology, the second reception circuit may include

a receiving unit,

a coupling unit,

an error correction unit, and

a second conversion unit,

the receiving unit may include a plurality of reception processing units,

the second transmission circuit may transmit the clock to the transmission apparatus, and

each of the plurality of reception processing units may receive packetized data transmitted from the transmission apparatus corresponding to each transmission path,

the coupling unit may generate a code word based on encoded data of the plurality of received packetized data,

the error correction unit may perform an error correction on an information word based on the error correction code included in the code word, and

the second conversion unit may output the error-corrected information word as symbol data.

In addition, a transmission system according to the present technology includes a transmission apparatus and a reception apparatus,

in which the transmission apparatus includes a first reception circuit and a first transmission circuit,

the reception apparatus includes a second transmission circuit and a second reception circuit,

the second transmission circuit transmits a clock to a transmission apparatus,

the first reception circuit receives the clock from the reception apparatus,

the first transmission circuit uses the received clock to transmit retention data retained by the first transmission circuit to the reception apparatus, and

the second reception circuit receives the retention data.

In the transmission system according to the present technology, the first transmission circuit may include a first conversion unit, a correction coding calculation unit, a division unit, and a transmitting unit,

the transmitting unit may include a plurality of transmission processing units,

the second reception circuit may include a receiving unit, a coupling unit, an error correction unit, and a second conversion unit.

the receiving unit may include a plurality of reception processing units,

when the second transmission circuit transmits a clock to the transmission apparatus and the first reception circuit receives the clock from the reception apparatus,

the first conversion unit may convert the retention data into units constituting a predetermined symbol and output each unit,

the correction coding calculation unit may calculate an error correction code in the data for each of the plurality of units,

the division unit may divide a code word obtained by adding the error correction code to the data of each of the plurality of units into encoded data, and allocate the divided encoded data to each of the plurality of transmission paths by a predetermined number so that the plurality of encoded data has the same amount of data in each of a plurality of transmission paths,

each of the plurality of transmission processing units may packetize the allocated data of the same amount of data and transmit the packetized data to the reception apparatus via the plurality of allocated transmission paths using the received clock,

each of the plurality of reception processing units may receive packetized data transmitted from the transmission apparatus corresponding to each of the plurality of transmission paths,

the coupling unit may generate a code word based on encoded data of the plurality of received packetized data,

the error correction unit may perform an error correction on an information word based on the error correction code included in the code word, and

the second conversion unit may output the error-corrected information word as symbol data.

According to the present technology, it is possible to provide a transmission apparatus, a reception apparatus, and a transmission system that operate at the same clock as the reception apparatus without mounting an oscillation circuit on the transmission apparatus and realize a low error rate. Note that the effect of the present technology is not necessarily limited to the above effects, and may be any of the effects described in the present technology.

### BRIEF DESCRIPTION OF DRAWINGS

FIG. 1 is a block diagram illustrating a transmission system which is an example of a transmission system of a first embodiment according to the present technology.

FIG. 2 is a block diagram illustrating a transmission system which is an example of a transmission system of a second embodiment according to the present technology.

FIG. 3 is a block diagram illustrating a transmission system which is an example of a transmission system of a third embodiment according to the present technology.

FIG. 4 is a block diagram illustrating a transmission system which is an example of a transmission system of a fourth embodiment according to the present technology.

FIG. 5 is a diagram illustrating a timing chart of the transmission system of the fourth embodiment according to the present technology.

FIG. 6 is a block diagram illustrating a transmission system which is an example of a transmission system of a fifth embodiment according to the present technology.

FIG. 7 is a diagram illustrating a timing chart of the transmission system of the fifth embodiment according to the present technology.

FIG. 8 is a block diagram illustrating a transmission system which is an example of a transmission system of a sixth embodiment according to the present technology.

FIG. 9 is a diagram illustrating a timing chart of the transmission system of the sixth embodiment according to the present technology.

FIG. 10 is a block diagram illustrating a transmission system which is an example of a transmission system of a seventh embodiment according to the present technology.

FIG. 11 is a block diagram illustrating a transmission system which is an example of a transmission system of an eighth embodiment according to the present technology.

FIG. 12 is a block diagram illustrating a transmission system which is an example of a transmission system of a ninth embodiment according to the present technology.

FIG. 13 is a block diagram illustrating a transmission system which is an example of a transmission system of a tenth embodiment according to the present technology.

FIG. 14 is a block diagram illustrating a transmission system which is an example of a transmission system of an eleventh embodiment according to the present technology.

FIG. 15 is a block diagram illustrating a transmission system which is an example of a transmission system of a twelfth embodiment according to the present technology.

FIG. 16 is a block diagram illustrating a transmission system which is an example of a transmission system of a thirteenth embodiment according to the present technology.

FIG. 17 is a block diagram illustrating a transmission system which is an example of a transmission system of a fourteenth embodiment according to the present technology.

FIG. 18 is a block diagram illustrating a transmission system which is an example of a transmission system of a fifteenth embodiment according to the present technology.

FIG. 19 is a block diagram illustrating details of a first transmission circuit (TX_T) and a second reception circuit (RX_R) in the transmission system of the fifteenth embodiment according to the present technology.

FIG. 20 is a diagram illustrating an example of rearranging retention data (transmission data).

FIG. 21 is a diagram illustrating an example of error correction coding.

FIG. 22 is a diagram illustrating an example of dividing a transmission path of the retention data (transmitted data).

FIG. 23 is a diagram illustrating another example of dividing the transmission path of the retention data (transmitted data).

FIG. 24 is a diagram illustrating a frame configuration of a transmission frame.

FIG. 25 is a diagram illustrating an example of coupling the transmission path of the retention data (transmitted data).

FIG. 26 is a diagram illustrating an example of error correction decoding.

FIG. 27 is a flowchart of describing transmission processing of the transmission apparatus (CIS).

FIG. 28 is a flowchart of describing reception processing of the reception apparatus (reception LSI).

FIG. 29 is a diagram illustrating a modification of the configuration of the transmission system.

FIG. 30 is a block diagram illustrating a transmission system which is an example of a transmission system of a sixteenth embodiment according to the present technology.

FIG. 31 is a block diagram illustrating a transmission system which is an example of a transmission system of a seventeenth embodiment according to the present technology.

FIG. 32 is an explanatory diagram illustrating that external data transmitted from an external apparatus and a differential clock of a second transmission circuit of the reception apparatus are superimposed to generate the superimposed data.

FIG. 33 is a block diagram illustrating a transmission system which is an example of a transmission system of an eighteenth embodiment according to the present technology.

FIG. 34 is an explanatory diagram illustrating that the external data transmitted from the external apparatus and a clock transmitted from the second transmission circuit of the reception apparatus are superimposed to generate the superimposed data.

FIG. 35 is a block diagram illustrating a transmission system which is an example of a transmission system of a nineteenth embodiment according to the present technology.

FIG. 36 is an explanatory diagram illustrating that the external data (SDA) transmitted from the external apparatus and the clock transmitted from the second transmission circuit of the reception apparatus and the external data and the clock are superimposed to generate the superimposed signal.

FIG. 37 is a block diagram illustrating a transmission system which is an example of a transmission system of a twentieth embodiment according to the present technology.

FIG. 38 is a block diagram illustrating a transmission system which is an example of a transmission system of a twenty-first embodiment according to the present technology.

FIG. 39 is a block diagram illustrating a transmission system which is an example of a transmission system of a twenty-second embodiment according to the present technology.

FIG. 40 is a block diagram illustrating a transmission system which is an example of a transmission system of a twenty-third embodiment according to the present technology.

FIG. 41 is a block diagram illustrating a transmission system which is an example of a transmission system of a twenty-fourth embodiment according to the present technology.

FIG. 42 is a block diagram illustrating a transmission system which is an example of a transmission system of a twenty-fifth embodiment according to the present technology.

FIG. 43 is a block diagram of the existing transmission system.

### MODE FOR CARRYING OUT THE INVENTION

Hereinafter, a suitable mode for carrying out the present technology will be described with reference to the drawings. Note that embodiments described below shows an example of a typical embodiment of the present technology, and the scope of the present technology is not narrowly interpreted by these embodiments.

Note that descriptions will be made in the following order.

1. Overview of present technology

2. First embodiment (example 1 of transmission system)

3. Second embodiment (example 2 of transmission system)

4. Third embodiment (example 3 of transmission system)

5. Fourth embodiment (example 4 of transmission system)

6. Fifth embodiment (example 5 of transmission system)

7. Sixth embodiment (example 6 of transmission system)

8. Seventh embodiment (example 7 of transmission system)

9. Eighth embodiment (example 8 of transmission system)

10. Ninth embodiment (example 9 of transmission system)

11. Tenth embodiment (example 10 of transmission system)

12. Eleventh embodiment (example 11 of transmission system)

13. Twelfth embodiment (example 12 of transmission system)

14. Thirteenth embodiment (example 13 of transmission system)

15. Fourteenth embodiment (example 14 of transmission system)

16. Fifteenth embodiment (example 15 of transmission system)

17. Sixteenth embodiment (example 16 of transmission system)

18. Seventeenth embodiment (example 17 of transmission system)

19. Eighteenth embodiment (example 18 of transmission system)

20. Nineteenth embodiment (example 19 of transmission system)

21. Twentieth embodiment (example 20 of transmission system)

22. Twenty-first embodiment (example 21 of transmission system)

23. Twenty-second embodiment (example 22 of transmission system)

24. Twenty-third embodiment (example 23 of transmission system)

25. Twenty-fourth embodiment (example 24 of transmission system)

26. Twenty-fifth embodiment (example 25 of transmission system)

### 1. Overview of Present Technology

First, an overview of the present technology will be described. The present technology relates to a configuration of a transmission apparatus in a transmission system. According to the present technology, since the transmission apparatus does not have an oscillation circuit, the transmission apparatus can be further miniaturized, reduced in power, reduced in noise, and have a low error rate.

In addition, since a phase locked loop (PLL) itself is not installed, an evaluation resource for PLL design and an intellectual property (IP) IP cost for purchasing IP are not required.

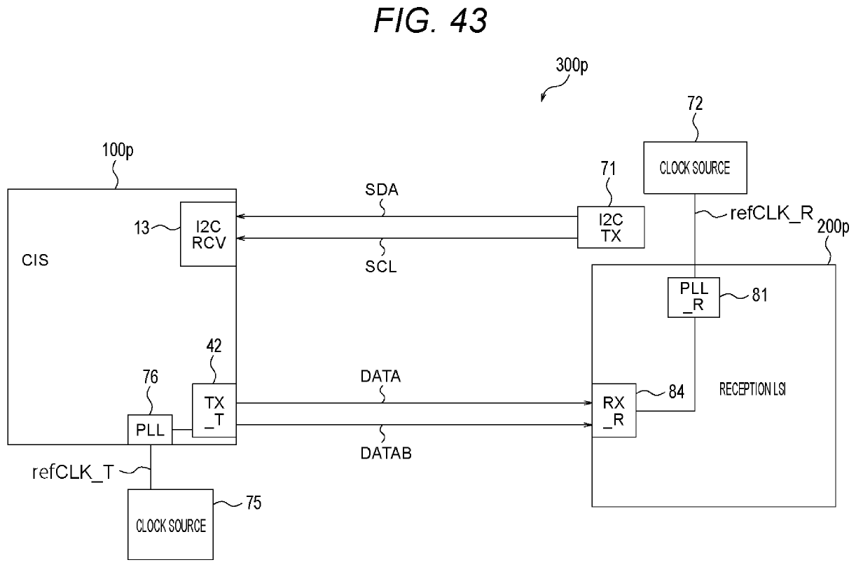

Here, the existing transmission system will be described. FIG. 43 is a block diagram of the existing transmission system. FIG. 43 is a block diagram of the existing transmission system.

As illustrated in FIG. 43, a transmission system 300p includes a complementary metal oxide semiconductor image sensor (CIS) 100p, reception large scale integration (LSI) 200p, an external apparatus (I2C TX 71), a clock source 72, and a clock source 75.

The CIS 100p is connected to the external apparatus (I2C TX 71). The external apparatus (I2C TX 71) is a transmission apparatus (master) in line with a high-speed interface standard that transmits serial data (SDA) and a serial clock line (SCL) to the CIS 100p. The CIS 100p receives external data (SDA) and the SCL from the external apparatus (I2C TX 71) with I2C RCV13. In addition, the CIS 100p is connected to the clock source 75. The CIS 100p receives a reference clock refCLK_T from the clock source 75 and drives an internal circuit (not illustrated). The CIS 100p has a phase locked loop (PLL) 76, and uses the reference clock refCLK_T received from the clock source 75 in the PLL 76 to transmit a retention data (DATA and DATAB) from a first transmission circuit (TX_T) 42 to the reception LSI 200p.

The reception LSI 200p is connected to the clock source 72. The reception LSI 200p receives the reference clock refCLK_R from the clock source 72 and drives the internal circuit. The reception LSI 200p has a PLL_R 81, and uses the reference clock refCLK_R received from the clock source 72 in the PLL 81 to receive the retention data (DATA and DATAB) transmitted from the CIS 100p in a second reception circuit (RX_R) 84.

Note that the external apparatus (I2C TX 71) constitutes the external apparatus, but may be mounted on the reception LSI 200p. In this case, the CIS 100p receives the external data (SDA) and the SCL from the I2C TX 71 mounted on the reception LSI 200p.

Here, examples of the second reception circuit (RX_R) 84 can include, as a circuit that synchronizes with a clock supplied from PLL_R 81, a delay circuit, a delay circuit with calibration, or a clock and data recovery circuit. Note that when a special modulation is applied in a first transmission circuit (TX_T) 42 of CIS 100p, the second reception circuit (RX_R) 84 includes a dedicated decoding circuit to demodulate the modulation.

Conventionally, the transmission system 300p has been configured by such a configuration. That is, since each of the CIS 100p and the reception LSI 200p operates on different clocks (reference clock refCLK_T and reference clock refCLK_R), a random jitter component became large and an error may occur. In addition, since the CIS 100p and the reception LSI 200p operate on different clocks (reference clock CLK_T and reference clock CLK_R), the quality of the transmitted retention data (DATA and DATAB) is not high.

Therefore, in the present technology, the CIS 100p does not have an oscillation circuit and adopts a configuration that acquires the clock from the reception LSI 200p, so operation frequencies transmitted and received within the transmission system 300p match and the quality of the retention data (DATA and DATAB) received by the reception LSI 200p can be significantly improved. In addition, for example, it is not necessary to insert or remove an elastic buffer for absorbing a difference in a center frequency of a transmission/reception PLL or a pattern for adjusting frequency fluctuation.

Furthermore, since the CIS 100p is not mounted with the PLL 76, a logic circuit that controls the PLL 76 can be reduced. At the same time, since the CIS 100p is not mounted with the PLL 76, in addition to the weight reduction, the crystal oscillator becomes unnecessary, and not only the CIS 100p but also the substrate itself on which the CIS 100p is mounted can be reduced in weight. As a result, for example, the substrate on which the CIS 100p is mounted can be floated by image stabilization, and high camera shake noise resistance can be given to a digital single-lens reflex camera.

In addition, the cost of the CIS 100p can be reduced by reducing the number of crystal oscillators.

### 2. First Embodiment (Example 1 of Transmission System

A transmission system of a first embodiment according to the present technology includes a transmission apparatus and a reception apparatus. A transmission apparatus is a transmission apparatus that includes a first reception circuit, and a first transmission circuit, in which the first reception circuit receives a clock from the reception apparatus, and the first transmission circuit synchronizes retention data retained by the first transmission circuit using the received clock, and transmits the retention data to the reception apparatus. The reception apparatus is a reception apparatus that includes a second transmission circuit and a second reception circuit, in which the second transmission circuit transmits a clock to the transmission apparatus, and the second reception circuit receives the retention data retained by the transmission apparatus.

According to the transmission system of the first embodiment of the present technology, since the transmission apparatus is not mounted with an oscillation circuit, the transmission apparatus can be miniaturized, reduced in power, reduced in noise, and have a low error rate.

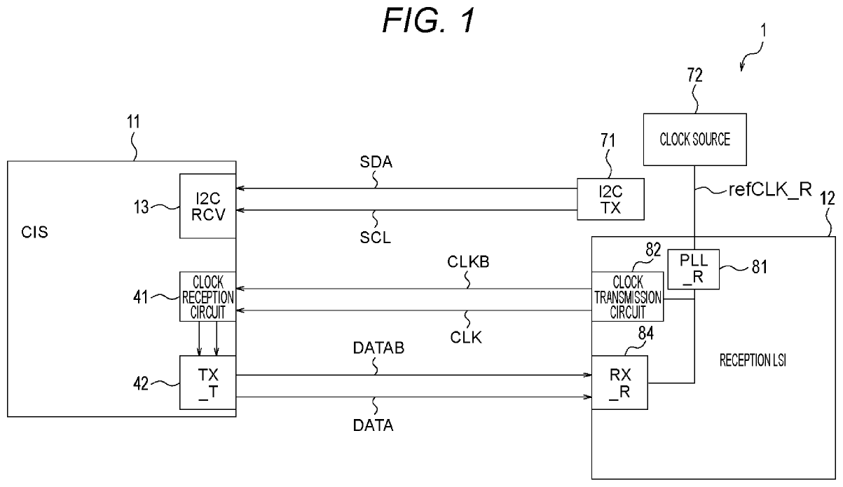

FIG. 1 is a block diagram illustrating a transmission system 1 which is an example of the transmission system of the first embodiment according to the present technology. FIG. 1 is a block diagram illustrating a configuration example of the transmission system 1 to which the present technology is applied. Note that unless otherwise specified, “upper” means an upper direction in FIG. 1, and “lower” means a lower direction in FIG. 1. Components common to the transmission system 300p illustrated in FIG. 43 are denoted by the same reference numerals, and descriptions thereof are omitted as appropriate.

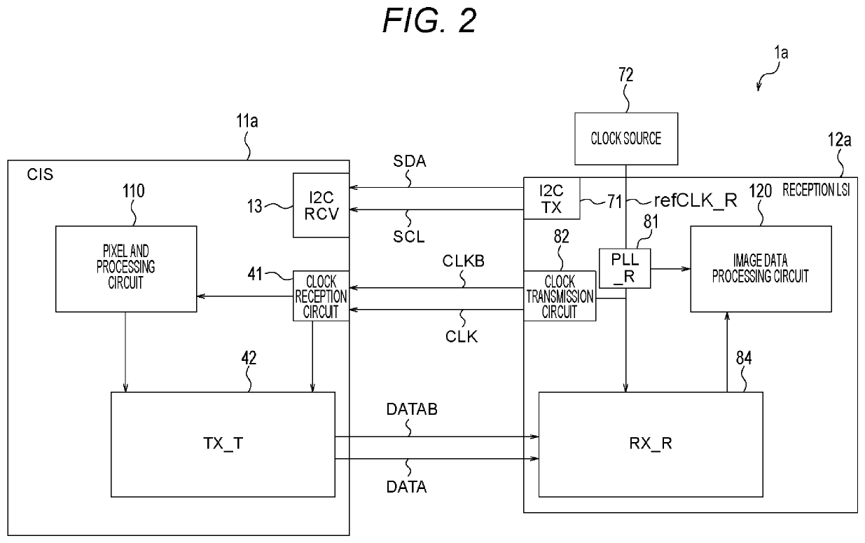

The transmission system 1 illustrated in FIG. 1 includes a transmission apparatus (CIS) 11, a reception apparatus (reception LSI) 12, an external apparatus (I2C TX 71), and a clock source 72. The transmission apparatus (CIS) 11 and the reception apparatus (reception LSI) 12 are realized by different large scale integrated circuits (LSIs), for example, and are provided in devices that process information such as digital cameras, mobile phones, and personal computers. Further, an external apparatus (I2C TX 71) may be provided in the reception apparatus (reception side block) 12. The configuration in this case will be described with reference to FIG. 2.

Next, the configuration of the transmission apparatus (CIS) 11 will be described. The transmission apparatus (CIS) 11 includes an I2C RCV13, a first reception circuit (clock reception circuit) 41, and a first transmission circuit (TX_T) 42.

The I2C RCV13 receives the external data (SDA) and the SCL transmitted from the external apparatus (I2C TX 71).

The first reception circuit (clock reception circuit) 41 receives the clock from the reception apparatus (reception LSI) 12.

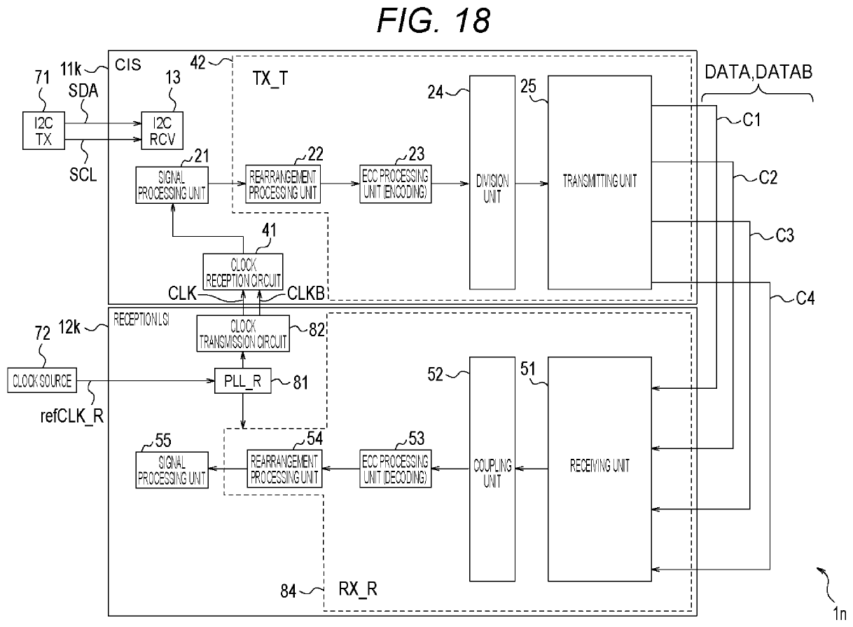

The first transmission circuit (TX_T) 42 has a transmitting unit (FIG. 18) described later, and the transmitting unit uses the received clock to transmit the data (retention data) retained by the transmission apparatus (CIS) 11 or the first transmission circuit (TX_T) 42 to the reception apparatus (reception LSI) 12.

Note that the data (retention data) retained by the transmission apparatus (CIS) 11 or the first transmission circuit (TX_T) 42 is, for example, image data. Further, the transmission apparatus (CIS) 11 may include an imaging unit, and the retention data may be a captured image imaged by the imaging unit.

Next, the configuration of the reception apparatus (LSI) 12 will be described. The reception apparatus (reception LSI) 12 includes a PLL_R 81, a second transmission circuit (clock transmission circuit) 82, and a second reception circuit (RX_R) 84.

The PLL_R 81 receives the clock from the clock source 72. The PLL_R 81 supplies the received clock to the second transmission circuit (clock transmission circuit) 82 and the second reception circuit (RX_R) 84.

The second transmission circuit (clock transmission circuit) 82 transmits clocks (CLK and CLKB) to the first reception circuit (clock reception circuit) 41 of the transmission apparatus (CIS) 11.

The second reception circuit (RX_R) 84 receives data (retention data) retained by the transmission apparatus (CIS) 11 or the first transmission circuit (TX_T) 42 from the first transmission circuit (TX_T) 42 of the transmission apparatus (CIS) 11.

With such a configuration, in the transmission system 1, the clocks (CLK and CLKB) are transmitted from the reception apparatus (reception LSI) 12 to the transmission apparatus (CIS) 11. The transmission apparatus (CIS) 11 receives the clocks (CLK and CLKB) transmitted from the reception apparatus (reception LSI) 12 in the first reception circuit (clock reception circuit) 41, and the first transmission circuit (TX_T) 42 uses the received clocks (CLK and CLKB) to transmit the retention data (DATA and DATAB) retained by the transmission apparatus (CIS) 11 or the first transmission circuit (TX_T) 42 to the reception apparatus (reception LSI) 12.

As a result, the transmission apparatus (CIS) 11 can drive the first transmission circuit (TX_T) 42 without changing the operation frequency of the received clock.

As described above, in the transmission system 1 of the first embodiment according to the present technology, the transmission apparatus (CIS) 11 operates at the same clock as reception apparatus (reception LSI) 12 without mounting an oscillation circuit, and can realize a low error rate, so it is possible to reduce the IP cost for purchasing design evaluation resources or intellectual property (IP) for PLL design.

In addition, the second reception circuit (RX_R) 84 of the reception apparatus (reception LSI) 12 can include a delay circuit, a delay circuit with calibration, a clock and data recovery circuit, and the like, and the second reception circuit can also align a phase of the data received by the second reception circuit (RX_R) 84.

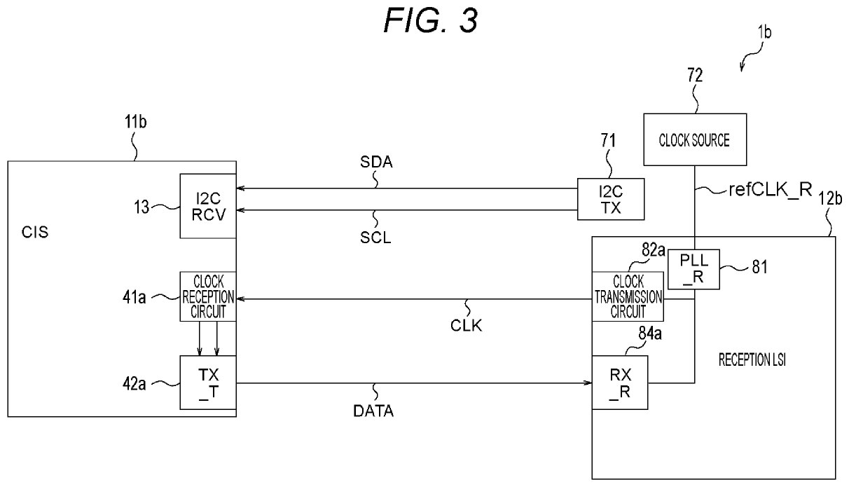

Note that in FIG. 1, the second transmission circuit (clock transmission circuit) 82 of the reception apparatus (reception LSI) 12 is supposed to transmit differential clocks (CLK and CLKB), but the clock to be transmitted can also be applied to a single-phase clock. Note that the single-phase clock will be described with reference to FIG. 3.

### 3. Second Embodiment (Example 2 of Transmission System

FIG. 2 illustrates a transmission system 1a which is an example of a transmission system of a second embodiment according to the present technology. FIG. 2 is a block diagram illustrating a configuration example of the transmission system 1a to which the present technology is applied. Note that unless otherwise specified, “upper” means an upper direction in FIG. 2, and “lower” means a lower direction in FIG. 2. In addition, components common to the above-described transmission system 1 illustrated in FIG. 1 are denoted by the same reference numerals, and descriptions thereof are omitted as appropriate.

In the transmission system 1a of the second embodiment according to the present technology illustrated in FIG. 2, the transmission apparatus (CIS) 11 of the transmission system 1 of the first embodiment according to the present technology illustrated in FIG. 1 further includes a pixel and processing circuit 110 indicating an internal circuit, and the reception apparatus (reception LSI) 12 is configured to further include an image data processing circuit 120 and an external apparatus (I2C TX 71).

In this case, a transmission apparatus (CIS) 11a does not change operation frequencies of clocks (CLK and CLKB) received in a first reception circuit (clock reception circuit) 41, and can drive either a first transmission circuit (TX_T) 42 or the pixel and the processing circuit 110.

Since a reception apparatus (reception LSI) 12a has an external apparatus (I2C TX 71), the reception apparatus (reception LSI) 12a can transmit external data (SDA) and SCL to the transmission apparatus (CIS) 11a. The transmission apparatus (CIS) 11a has the pixel and processing circuit 110, and can process pixels by the clock received by the first reception circuit (clock reception circuit) 41. Further, the reception apparatus (reception LSI) 12a has an image data processing unit 120, and can process retention data transmitted from the transmission apparatus (CIS) 11a by the image data processing unit 120.

As a result, each of the transmission apparatus (CIS) 11a and the reception apparatus (reception LSI) 12a operates at the same operation frequency and can be processed by the pixel and processing circuit 110 or the image data processing circuit 120, so a random jitter component does not increase and an error rate can be lowered.

### 4. Third Embodiment (Example 3 of Transmission System

FIG. 3 illustrates a transmission system 1b which is an example of a transmission system of a third embodiment according to the present technology. FIG. 3 is a block diagram illustrating a configuration example of a transmission system 1b to which the present technology is applied. Note that unless otherwise specified, “upper” means an upper direction in FIG. 3, and “lower” means a lower direction in FIG. 3. In addition, components common to the above-described transmission systems 1, la are denoted by the same reference numerals, and the descriptions thereof are omitted as appropriate.

As illustrated in FIG. 3, in the transmission system 1b of the third embodiment according to the present technology, a second transmission circuit (clock transmission circuit) 82a of a reception apparatus (reception LSI) 12b transmits a single-phase clock (CLK), and a first reception circuit (clock reception circuit) 41a of a transmission apparatus (CIS) 11b receives the single-phase clock (CLK). In addition, in the transmission apparatus (CIS) 11b, a first transmission circuit (TX_T) 42a transmits retention data (DATA) to the reception apparatus (reception LSI) 12b, and a second reception circuit (RX_R) 84a of the reception apparatus (reception LSI) 12b receives the retention data (DATA).

In this way, the transmission system 1b of the third embodiment according to the present technology can transmit and receive a single-phase clock (CLK) and transmit the retention data (DATA) to the reception apparatus (reception LSI) 12b.

Note that in this case, a potential difference between the transmission apparatus (CIS) 11 and the reception apparatus (reception LSI) 12 may cause jitter. Therefore, for example, the ground of the transmission apparatus (transmission side block) 11b and the reception apparatus (reception side block) 12b is made common, or resistance is reduced, or alternating currents of the transmission apparatus (transmission side block) 11b and the reception apparatus (reception side block) 12b are AC-coupled to each other. Also, since ground values of the transmission apparatus (transmission side block) 11b and the reception apparatus (reception side block) 12b may differ, AC coupling is performed. Also, since ground values of the transmission apparatus (transmission side block) 11b and the reception apparatus (reception side block) 12b may differ, AC coupling is performed.

In the case of the AC coupling, when positive and negative signals are not balanced, a signal may be biased to either “H” or “L”. To avoid this, it is preferable to perform 8B10B or Manchester coding.

In addition, in the transmission apparatus (CIS) 11b, not only a single-phase clock or a differential clock but also either a single-phase signal or a differential signal in which the external data transmitted from the external apparatus (I2C TX 71) and the clock transmitted from the reception apparatus (reception LSI) 12b are superimposed may be received.

### 5. Fourth Embodiment (Example 4 of Transmission System

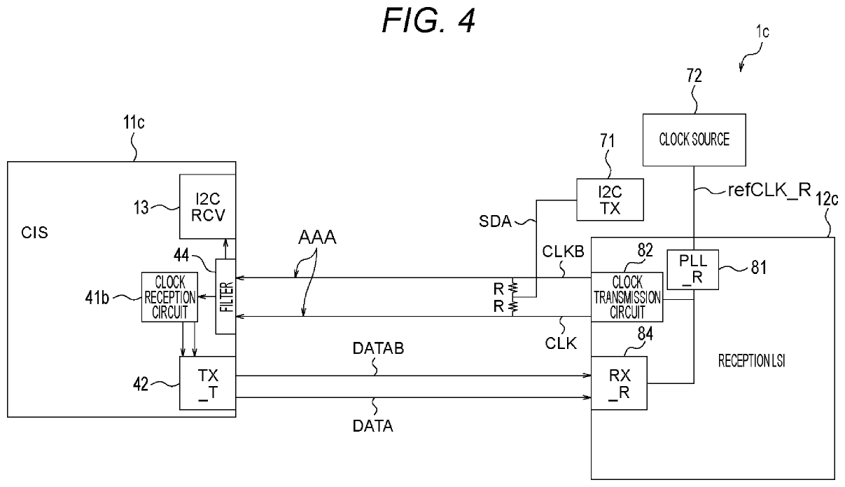

FIG. 4 illustrates a transmission system 1c which is an example of a transmission system of a fourth embodiment according to the present technology. FIG. 4 is a block diagram illustrating a configuration example of the transmission system 1c to which the present technology is applied. Note that unless otherwise specified, “upper” means an upper direction in FIG. 4, and “lower” means a lower direction in FIG. 4. In addition, components common to the above-described transmission systems 1 and 1b are denoted by the same reference numerals, and descriptions thereof are omitted as appropriate.

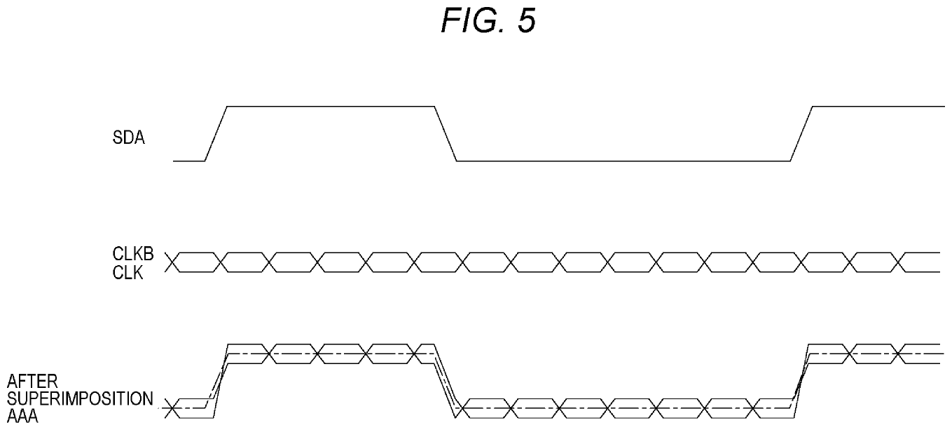

FIG. 5 illustrates a timing chart of the transmission system 1c which is an example of the transmission system of the fourth embodiment according to the present technology. FIG. 5 is an explanatory diagram illustrating external data (SDA) transmitted from an external apparatus (I2C TX 71), clocks (CLK and CLKB) of a second transmission circuit (TX_R) 82 of a reception apparatus (reception side block) 12c, and a superimposed signal AAA in which the external data (SDA) and the clocks (CLK and CLKB) are superimposed.

As illustrated in FIG. 4, the transmission system 1c of the fourth embodiment according to the present technology further includes a filter 44 in a transmission apparatus (CIS) 11c. The transmission system 1c of the fourth embodiment according to the present technology vibrates the clock (CLK and CLKB) transmitted from the second transmission circuit (clock transmission circuit) 82 and the external data (SDA) of the external apparatus (I2C TX 71) in a differential common level. In the fourth embodiment, since the external data (SDA) of the external apparatus (I2C TX 71) can be superposed in the common level outside the reception apparatus (reception LSI) 12c, the reception apparatus (reception LSI) 12c does not require a special mechanism.

As a result, the transmission apparatus (CIS) 11c can receive a differential signal in which the external data (SDA) transmitted from the external apparatus (I2C TX 71) and the clocks (CLK and CLKB) transmitted from the reception apparatus (reception LSI) 12b are superimposed.

The transmission apparatus (CIS) 11c includes the filter 44, and the filter 44 separates the clocks (CLK and CLKB) transmitted from the reception apparatus (reception LSI) 12c from the signal AAA in which the external data (SDA) transmitted from the external apparatus (I2C TX 71) and the clocks (CLK and CLKB) transmitted from the reception apparatus (reception LSI) 12c are superimposed. Further, the filter 44 transmits the separated clocks (CLK and CLKB) to the first reception circuit (clock reception circuit) 41b, and transmits the external data (SDA) to I2CRCV13.

Note that by superimposing the external data (SDA) of the external apparatus (I2C TX 71) on the clocks (CLK and CLKB) during a blanking period, the quality of the superimposed signal AAA is not affected. Therefore, when superimposing the external data (SDA) on the clocks (CLK and CLKB), it is preferable to use the blanking period in which transmission apparatus (CIS) 11c transmits the retention data (DATA and DATA B).

Further, in the transmission system 1c of the fourth embodiment, the external data (SDA) of the external apparatus (I2C TX 71) is superimposed on the clocks (CLK and CLKB), but is not limited thereto, and for example, the reference clock refCLK_R and the SCL of the external apparatus (I2C TX 71) may be integrated. In this case, so the reception apparatus (reception LSI) 12c can generate the SCL of the external apparatus (I2C TX 71) inside the reception apparatus (reception LSI) 12c, and can be based on the crystal oscillator of the clock source 72, it is possible to reduce the jitter difference between the transmission and reception clocks.

Note that in FIG. 4, a circuit that superimposes the external data (SDA) of the external apparatus (I2C TX 71) on the clocks (CLK and CLKB) is arranged outside the reception apparatus (reception LSI) 12c, but the reception apparatus (reception LSI) 12c may be provided.

### 6. Fifth Embodiment (Example 5 of Transmission System

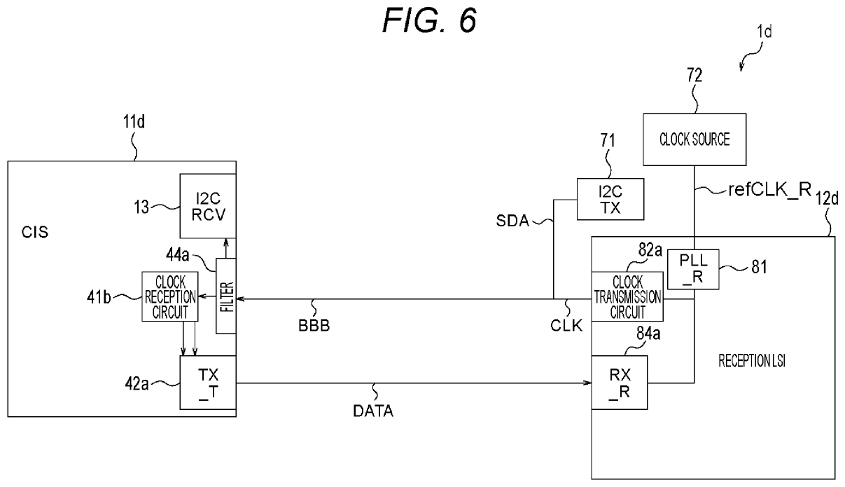

FIG. 6 illustrates a transmission system 1d which is an example of a transmission system of a fifth embodiment according to the present technology. FIG. 6 is a block diagram illustrating a configuration example of the transmission system 1d to which the present technology is applied. Note that unless otherwise specified, “upper” means an upper direction in FIG. 6, and “lower” means a lower direction in FIG. 6. In addition, components common to the above-described transmission systems 1 to 1c are denoted by the same reference numerals, and descriptions thereof are omitted as appropriate.

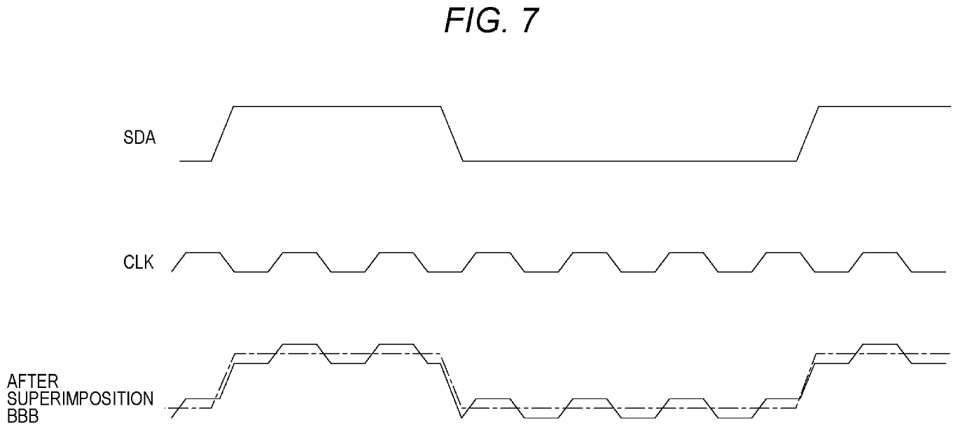

FIG. 7 illustrates a timing chart of the transmission system 1d which is an example of the transmission system of the fifth embodiment according to the present technology. FIG. 7 is an explanatory diagram illustrating external data (SDA) transmitted from an external apparatus (I2C TX 71), a clock (CLK) of a second transmission circuit (TX_R) 82a of a reception apparatus (reception side block) 12d, and a superimposed signal BBB in which the external data (SDA) and the clock (CLK) are superimposed.

As illustrated in FIG. 6, the transmission system 1d of the fifth embodiment according to the present technology includes a filter 44a. The transmission system 1d of the fifth embodiment according to the present technology superimposes the external data (SDA) of the external apparatus (I2C TX 71) on the clock (CLK) by wired OR. As a result, the transmission apparatus (CIS) 11d receives a single-phase signal in which the external data (SDA) transmitted from the external apparatus (I2C TX 71) and the clock (CLK) transmitted from the reception apparatus (reception LSI) 12d are superimposed.

In this way, the transmission apparatus (CIS) 11d can receive a signal in which the external data (SDA) transmitted from the external apparatus (I2C TX 71) and the clock transmitted from the reception apparatus (reception LSI) 12d are superimposed.

In addition, the transmission apparatus (CIS) 11d includes the filter 44a, and the filter 44a separates the clock (CLK) transmitted from the reception apparatus (reception LSI) 12d from the signal in which the external data (SDA) transmitted from the external apparatus (I2C TX 71) and the clock (CLK) transmitted from the reception apparatus (reception LSI) 12d are superimposed. Further, the filter 44a transmits the separated clock (CLK) to the first reception circuit (clock reception circuit) 41b, and transmits the external data (SDA) to I2CRCV13.

The transmission apparatus (CIS) 11d includes a first transmission circuit (TX_T) 42a, and the first transmission circuit (TX_T) 42a transmits retention data (DATA) to the reception apparatus (reception LSI) 12d. The reception apparatus (reception LSI) 12d receives the retention data (DATA) transmitted from the first transmission circuit (TX_T) 42a of the transmission apparatus (CIS) 11d in a second reception circuit (RX_R) 84a.

### 7. Sixth Embodiment (Example 6 of Transmission System

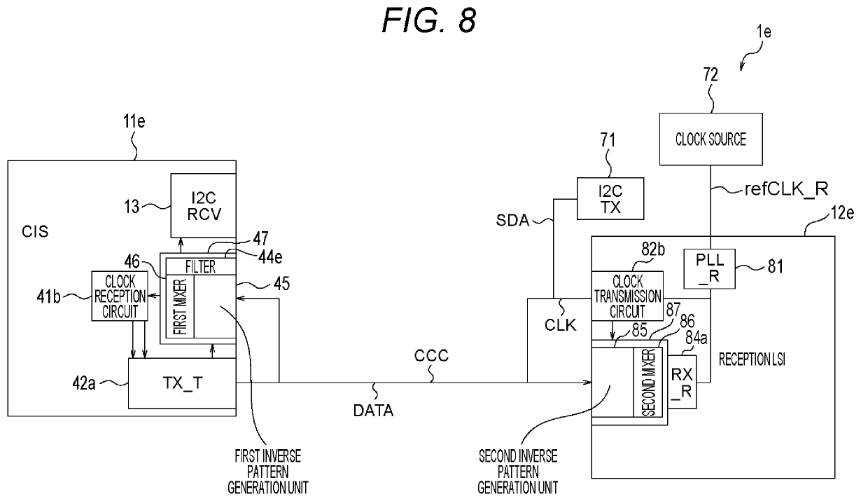

FIG. 8 is a block diagram illustrating a transmission system 1e which is an example of a transmission system of a sixth embodiment according to the present technology. FIG. 8 is a block diagram illustrating a configuration example of the transmission system 1e to which the present technology is applied. Note that unless otherwise specified, “upper” means an upper direction in FIG. 8, and “lower” means a lower direction in FIG. 8. In addition, components common to the above-descried transmission systems 1 to 1d are denoted by the same reference numerals, and descriptions thereof are omitted as appropriate.

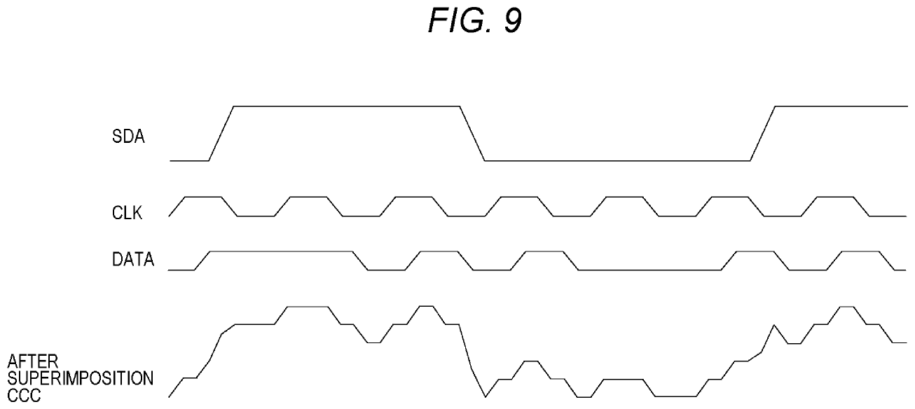

FIG. 9 illustrates a timing chart of a transmission system 1e which is an example of the transmission system of the sixth embodiment according to the present technology. FIG. 9 is an explanatory diagram illustrating an external data (SDA) transmitted from an external apparatus (I2C TX 71), a clock (CLK) transmitted from a second transmission circuit (TX_R) 82b of a reception apparatus (reception block) 12e, retention data (DATA) transmitted from a first transmission circuit (TX_T) 42a of a transmission apparatus (CIS) 11d, and a superimposed signal CCC in which the external data (SDA), the clock (CLK), and the retention data (DATA) are superimposed.

As illustrated in FIG. 8, the transmission system 1e of the sixth embodiment according to the present technology further includes a first transmission pattern cancel filter 47 in the transmission apparatus (CIS) 11e and a second transmission pattern cancel filter 87 in the reception apparatus (reception LSI) 12e. The transmission system 1e of the sixth embodiment according to the present technology is configured so that in the transmission system 1d of the fifth embodiment, the retention data (DATA) transmitted from the first transmission circuit (TX_T) 42a of the transmission apparatus (CIS) 11d is also superimposed on a signal in which the external data (SDA) transmitted from the external apparatus (I2C TX 71) is superimposed on the clock (CLK) transmitted from the second transmission circuit (TX_R) 82b of the reception apparatus (reception LSI) 12d.

The transmission apparatus (CIS) 11e receives a superimposed signal CCC in which the external data (SDA) transmitted from the external apparatus (I2C TX 71), the clock (CLK) transmitted from the reception apparatus (reception LSI) 12e, and the retention data (DATA) transmitted from transmission apparatus (CIS) 11e to the reception apparatus (reception LSI) 12e are superimposed.

In this case, the transmission apparatus (CIS) 11e includes a first transmission pattern cancel filter 47, and the first transmission pattern cancel filter 47 includes a first inverse pattern generation unit 45, a first mixer 46, and a filter 44e. The first inverse pattern generation unit 45 may generate a first inverse pattern having a waveform opposite to a waveform of the retention data (DATA). The first mixer 46 mixes the generated first inverse pattern with the signal CCC in which the external data (SDA) transmitted from the external apparatus (I2C TX 71), the clock (CLK) transmitted from the reception apparatus (reception LSI) 12e, and the retention data (DATA) are superimposed, cancels the waveform of the retention data (DATA) from the signal CCC in which the external data (SDA) transmitted from the external apparatus (I2C TX 71), the clock (CLK) transmitted from the reception apparatus (reception LSI) 12e, and the retention data (DATA) are superimposed to separate the clock (CLK) transmitted from the reception apparatus (reception LSI) 12e and external data (SDA). In this way, the first mixer 46 can separate the clock (CLK) transmitted from the reception apparatus (reception LSI) 12e and the external data (SDA).

The filter 44e separates the clock (CLK) and the external data (SDA) from the signal in which the clock (CLK) and the external data (SDA) are superimposed. The first transmission pattern cancel filter 47 transmits the external data (SDA) separated by the filter 44e to the I2CRCV13 and transmits the clock (CLK) to the first reception circuit (clock reception circuit) 41b. Note that the filter 44e includes, for example, a frequency filter and a voltage detection filter. For example, in a case where frequency bands of the clock (CLK) and the external data (SDA) are different, the filter 44e can include a frequency filter. In this case, since the frequency bands of the clock (CLK) and the external data (SDA) are different, the filter 44e can separate the clock (CLK) and the external data (SDA) according to the frequency bands.

Further, in a case where the frequency bands of the clock (CLK) and the external data (SDA) are the same, the filter 44e may include a voltage detection filter instead of the frequency filter. In this case, the filter 44e can separate the external data (SDA) from the clock (CLK) by the voltage value detected by the voltage detection filter.

Note that in a case where the first transmission pattern cancel filter 47 can acquire a differential signal of the retention data (DATA), the first mixer 46 may mix the differential signal of the retention data (DATA) with the signal in which the external data (SDA) transmitted from the external apparatus (I2C TX 71), the clock (CLK) transmitted from the reception apparatus (reception LSI) 12e, and the retention data (DATA) are superimposed, cancel the waveform of the retention data (DATA) from the signal in which the external data (SDA) transmitted from the external apparatus (I2C TX 71), the clock (CLK) transmitted from the reception apparatus (reception LSI) 12e, and the retention data (DATA) are superimposed to separate the clock (CLK) transmitted from reception apparatus (reception LSI) 12e and the external data (SDA). In this case, even without the first inverse pattern generation unit 45, the first transmission pattern cancel filter 47 can realize the process of separating the clock (CLK) and the external data (SDA) in an integrated manner.

In addition, the reception apparatus (reception LSI) 12e includes a second transmission pattern cancel filter 87, and the second transmission pattern cancel filter 87 includes a second inverse pattern generation unit 85 and a second mixer 86. The second inverse pattern generation unit 85 generates a second inverse pattern having a waveform opposite to the waveform of the external data (SDA) and a third inverse pattern having a waveform opposite to the waveform of the clock (CLK) transmitted from the reception apparatus (reception LSI) 12e. The second mixer 86 mixes the generated second inverse pattern waveform and third inverse pattern waveform with the signal CCC in which the external data (SDA) transmitted from the external apparatus (I2C TX 71), the clock (CLK) transmitted from the reception apparatus (reception LSI) 12e, and the retention data (DATA) are superimposed, cancels the waveform of the external data (SDA) and the waveform of the clock (CLK) transmitted from the reception apparatus (reception LSI) 12e from the signal CCC in which the external data (SDA) transmitted from the external apparatus (I2C TX 71), the clock (CLK) transmitted from the reception apparatus (reception LSI) 12e, and the retention data (DATA) are superimposed to separate the retention data (DATA). In this way, the second transmission pattern cancel filter 87 can separate the retention data (DATA).

Note that in a case where the differential signal of the waveform of the external data (SDA) and the differential signal of the clock transmitted from the reception apparatus (reception LSI) 12 can be acquired, the second transmission pattern cancel filter 87 may mix the differential signal of the waveform of the external data (SDA) and the differential signal of the clock (CLK) transmitted from the reception apparatus (reception LSI) 12e with the signal in which the external data (SDA) transmitted from the external apparatus (I2C TX 71), the clock (CLK) transmitted from the reception apparatus (reception LSI) 12e, and the retention data (DATA) are superimposed, and cancel the waveform of the external data (SDA) and the waveform of the clock (CLK) transmitted from the reception apparatus (reception LSI) 12e from the signal in which the external data (SDA) transmitted from the external apparatus (I2C TX 71), the clock (CLK) transmitted from the reception apparatus (reception LSI) 12e, and the retention data (DATA) are superimposed to separate the retention data (DATA). In this case, even if there is no second inverse pattern generation unit 85, the second transmission pattern cancel filter 87 can realize the process of separating the retention data (DATA) in an integrated manner.

Note that the second transmission pattern cancel filter 87 may include a frequency filter in the case where the frequency bands of the clock (CLK) and the external data (SDA) are different. In the case where the second transmission pattern cancel filter 87 includes, for example, a frequency filter, even if a second inverse pattern having a waveform opposite to a waveform of the external data (SDA) is not generated in the second inverse pattern generation unit 85, since the frequency bands of the clock (CLK) and the external data (SDA) are different, the clock (CLK) and the external data (SDA) can be separated according to the frequency bands.

Further, in the case where the frequency bands of the clock (CLK) and the external data (SDA) are the same, the second transmission pattern cancel filter 87 may include the voltage detection filter instead of the frequency filter. In this case, the second transmission pattern cancel filter 87 can separate the external data (SDA) from the clock (CLK) by the voltage value detected by the voltage detection filter.

Then, the second transmission pattern cancel filter 87 transmits the retention data (DATA) separated by the second mixer 86 to the second reception circuit (RX_R) 84a.

Note that in the sixth embodiment related to the present technology, the external data (SDA) transmitted from the external apparatus (I2C TX 71) and the clock (CLK) and retention data (DATA) transmitted from the reception apparatus (reception LSI) 12 are superimposed, but at least one of the external data (SDA), the clock (CLK), and the retention data (DATA and DATAB) may be differentiated.

For example, the embodiment in which each of the retention data (DATA and DATAB) and the clocks (CLK and CLKB) is differentiated is shown as a seventh embodiment, the embodiment in which the retention data (DATA and DATAB) is differentiated is shown as an eighth embodiment, and an embodiment in which the external data (SDA and SDAB), the clocks (CLK and CLKB), and the retention data (DATA and DATAB) are differentiated is shown as a ninth embodiment.

### 8. Seventh Embodiment (Example 7 of Transmission System

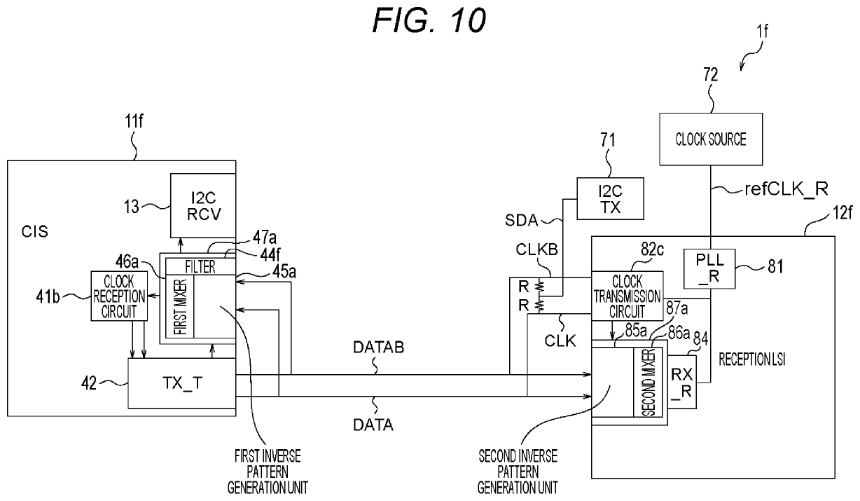

FIG. 10 illustrates a transmission system 1f that is an example of a transmission system according to a seventh embodiment of the present technology. FIG. 10 is a block diagram illustrating a configuration example of a transmission system 1f to which the present technology is applied. Note that unless otherwise specified, “upper” means an upper direction in FIG. 10, and “lower” means a lower direction in FIG. 10. In addition, components common to those of the above-described transmission system 1 to 1e are denoted by the same reference numerals, and description thereof will be omitted as appropriate.

As illustrated in FIG. 10, in a transmission system 1f of the seventh embodiment according to the present technology, external data (SDA), a clock (CLK), and retention data (DATA and DATAB) are superimposed, similarly to the transmission system 1e of the sixth embodiment.

The transmission system 1f of the seventh embodiment is different from the transmission system 1e of the sixth embodiment in that the external data (SDA) is made into a single phase, and the external data (SDA) is subjected to common mode modulation on the clocks (CLK and CLKB). In addition, the clock (CLK and CLKB) and the retention data (DATA and DATAB) are modulated by wired OR and differentiated.

### 9. Eighth Embodiment (Example 8 of Transmission System

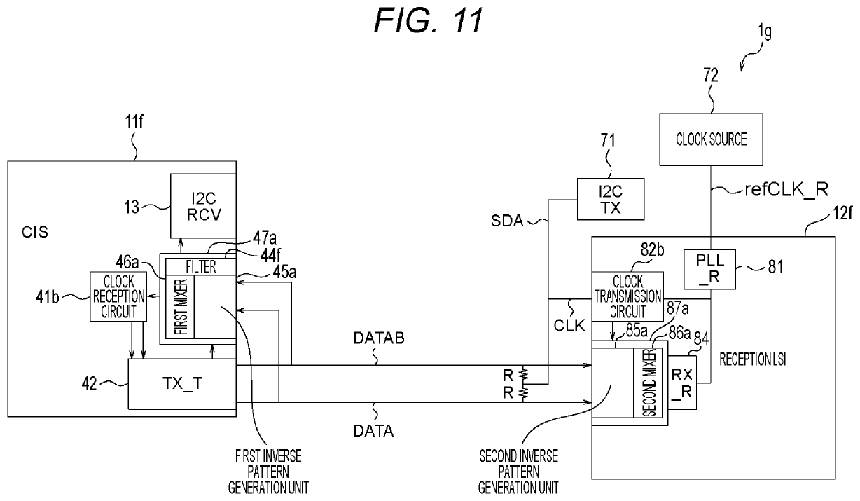

FIG. 11 illustrates a transmission system 1g that is an example of a transmission system according to an eighth embodiment of the present technology. FIG. 11 is a block diagram illustrating a configuration example of a transmission system 1g to which the present technology is applied. Note that unless otherwise specified, “upper” means an upper direction in FIG. 11, and “lower” means a lower direction in FIG. 11. In addition, components common to those of the above-described transmission system 1 to 1f are denoted by the same reference numerals, and description thereof will be omitted as appropriate.

As illustrated in FIG. 11, in the transmission system 1g of the eighth embodiment according to the present technology, external data (SDA), a clock (CLK), and retention data (DATA and DATAB) are superimposed, similarly to the transmission system 1f of the seventh embodiment.

The transmission system 1g of the eighth embodiment is different from the transmission system 1f of the seventh embodiment in that the external data (SDA) and the clock (CLK) are made into a single phase, and the retention data (DATA and DATAB) is differentiated. In this case, the external data (SDA) and the clock (CLK) are modulated by wired OR, and the retention data (DATA and DATAB) is modulated by the common mode on the modulated signal.

### 10. Ninth Embodiment (Transmission System Example 9

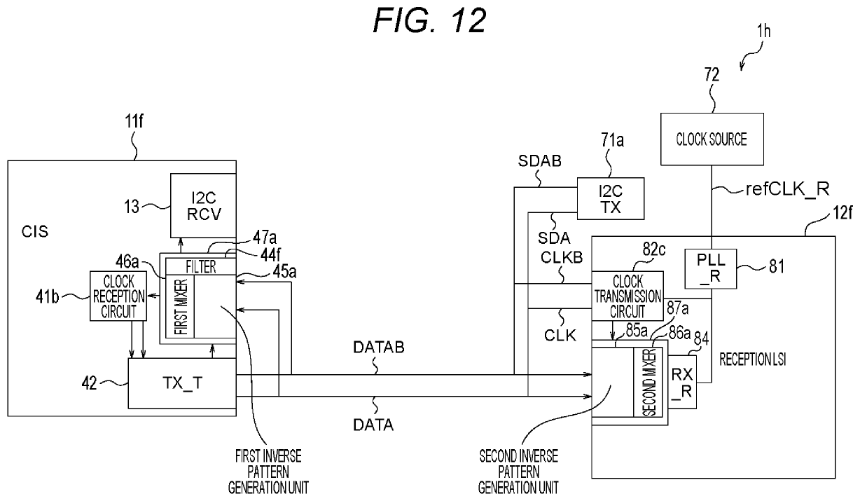

FIG. 12 illustrates a transmission system 1h that is an example of a transmission system according to a ninth embodiment of the present technology. FIG. 12 is a block diagram illustrating a configuration example of a transmission system 1h to which the present technology is applied. Note that unless otherwise specified, “upper” means an upper direction in FIG. 11, and “lower” means a lower direction in FIG. 12. In addition, components common to those of the above-described transmission system 1 to 1g are denoted by the same reference numerals, and description thereof will be omitted as appropriate.

As illustrated in FIG. 12, in a transmission system 1h according to a ninth embodiment of the present technology, external data (SDA and SDAB), clocks (CLK and CLKB), and retention data (DATA and DATAB) are superimposed.

The transmission system 1h of the ninth embodiment is different from the transmission system if of the seventh embodiment in that all of the external data (SDA and SDAB), the clocks (CLK and CLKB), and the retention data (DATA and DATAB) are differentiated. In this case, the external data (SDA), the clock (CLK), and the retention data (DATA) are modulated by wired OR, and the external data (SDAB), the clock (CLKB), and the retention data (DATAB) are modulated by wired OR.

### 11. Tenth Embodiment (Example of Transmission System 10

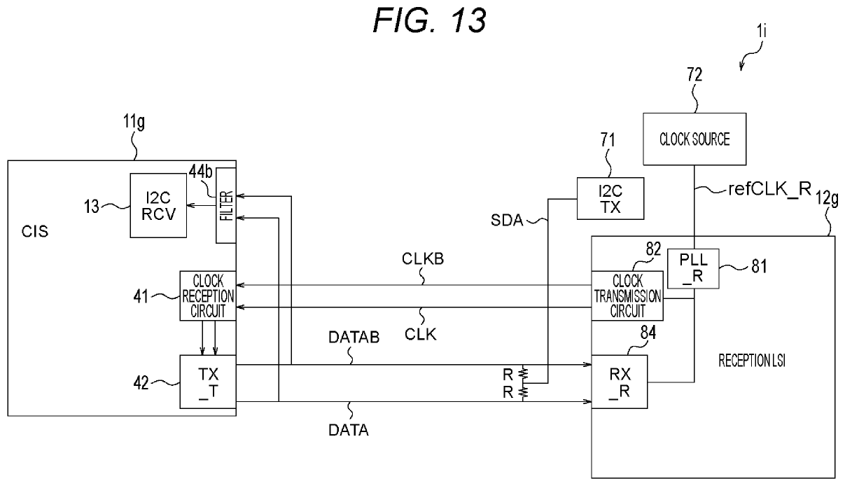

FIG. 13 illustrates a transmission system 1i that is an example of a transmission system according to a tenth embodiment of the present technology. FIG. 13 is a block diagram illustrating a configuration example of a transmission system 1i to which the present technology is applied. Note that unless otherwise specified, “upper” means an upper direction in FIG. 13, and “lower” means a lower direction in FIG. 13. In addition, components common to those of the above-described transmission system 1 to 1h are denoted by the same reference numerals, and description thereof will be omitted as appropriate.

As illustrated in FIG. 13, in the transmission system 1i according to the tenth embodiment of the present technology, external data (SDA) and retention data (DATA and DATAB) are superimposed, and the external data (SDA) is a single-phase signal. Further, the clocks (CLK and CLKB) and the retention data (DATA and DATAB) transmitted from the reception apparatus (reception LSI) 12g constitute differential signals. Note that the external data (SDA) is configured to apply common mode modulation to the retention data (DATA and DATAB).

The filter 44b separates the external data (SDA) from a signal in which the external data (SDA) transmitted from an external apparatus (I2C TX 71) and the retention data (DATA and DATAB) are superimposed.

### <12. Eleventh Embodiment (Example of Transmission System

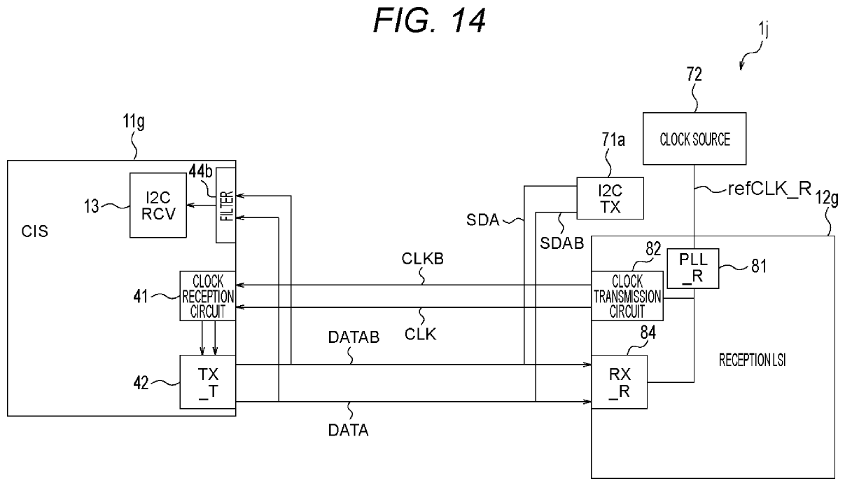

FIG. 14 illustrates a transmission system 1j that is an example of a transmission system according to an eleventh embodiment of the present technology. FIG. 14 is a block diagram illustrating a configuration example of the transmission system 1j to which the present technology is applied. Note that unless otherwise specified, “upper” means an upper direction in FIG. 14, and “lower” means a lower direction in FIG. 14. In addition, components common to those of the above-described transmission system 1 to 1i are denoted by the same reference numerals, and description thereof will be omitted as appropriate.

As illustrated in FIG. 14, in the transmission system 1j of the eleventh embodiment according to the present technology, external data (SDA and SDAB) transmitted from an external apparatus (I2C TX 71a) and retention data (DATA and DATAB) are superimposed. In addition, each of the external data (SDA and SDAB), the clocks (CLK and CLKB) transmitted from the reception apparatus (reception LSI) 12g, and the retention data (DATA and DATAB) constitutes a differential signal. The external data (SDA and SDAB) is configured to modulate the retention data (DATA and DATAB) by wired OR.

The filter 44b separates the external data (SDA and SDAB) from a signal in which the external data (SDA and SDAB) transmitted from the external apparatus (I2C TX 71a) and the retention data (DATA and DATAB) are superimposed.

### 13. Twelfth Embodiment (Example of Transmission System 12

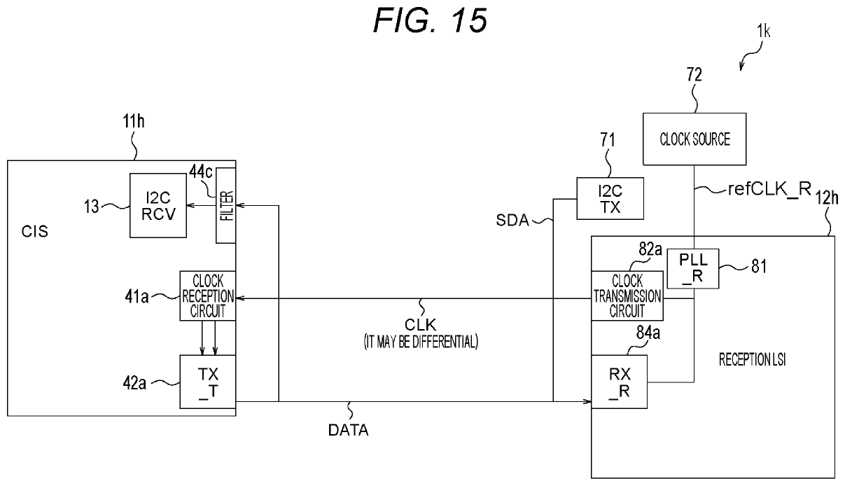

FIG. 15 illustrates a transmission system 1k that is an example of a transmission system according to a twelfth embodiment of the present technology. FIG. 15 is a block diagram illustrating a configuration example of the transmission system 1k to which the present technology is applied. Note that unless otherwise specified, “upper” means an upper direction in FIG. 15, and “lower” means a lower direction in FIG. 15. In addition, components common to those of the above-described transmission system 1 to 1j are denoted by the same reference numerals, and description thereof will be omitted as appropriate.

As illustrated in FIG. 15, in the transmission system 1k according to the twelfth embodiment of the present technology, external data (SDA) transmitted from an external apparatus (I2C TX 71) and retention data (DATA) are superimposed. Each of the external data (SDA) and the retention data (DATA) is a single-phase signal. In this case, the external data (SDA) is configured to modulate the retention data (DATA) by wired OR. In the reception apparatus (reception LSI) 12h, the clock (CLK) transmitted from the second transmission circuit (clock transmission circuit) 82a is configured as a single-phase clock, but may be configured as a differential clock.

The filter 44c separates the external data (SDA) from a signal in which the external data (SDA) transmitted from the external apparatus (I2C TX 71) and the retention data (DATA) are superimposed.

### 14. Thirteenth Embodiment (Example of Transmission System 13

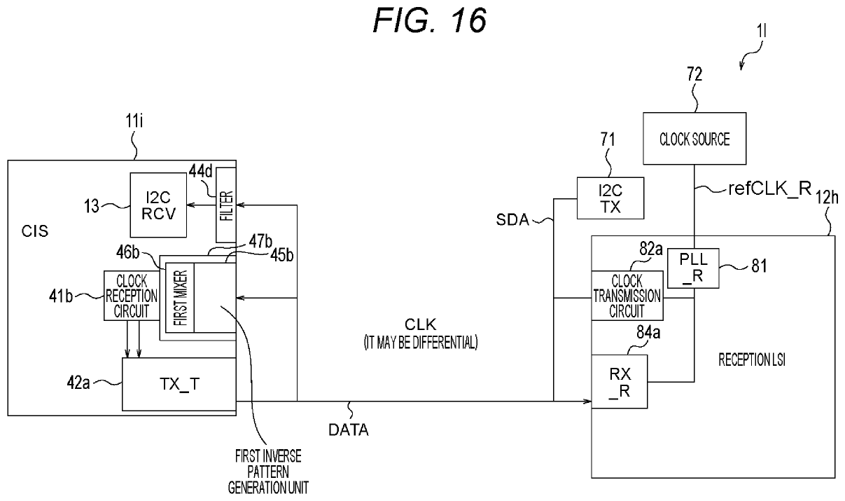

FIG. 16 illustrates a transmission system 1l that is an example of a transmission system according to a thirteenth embodiment of the present technology. FIG. 16 is a block diagram illustrating a configuration example of a transmission system 1l to which the present technology is applied. Note that unless otherwise specified, “upper” means an upper direction in FIG. 16, and “lower” means a lower direction in FIG. 16. In addition, components common to those of the above-described transmission system 1 to 1k are denoted by the same reference numerals, and description thereof will be omitted as appropriate.

As illustrated in FIG. 16, in the transmission system 1l according to the thirteenth embodiment of the present technology, external data (SDA) transmitted from an external apparatus (I2C TX 71), a clock (CLK) transmitted from a reception apparatus (reception LSI) 12h, and retention data (DATA) are superimposed. The external data (SDA) is modulated by wired OR on the clock (CLK) transmitted from the reception apparatus (reception LSI) 12h. The modulated signal is configured so that the retention data (DATA) is modulated by the wired OR. Note that the clock (CLK) transmitted from the reception apparatus (reception LSI) 12h may be a differential clock.

A filter 44d separates the external data (SDA) from a signal in which the external data (SDA) transmitted from the external apparatus (I2C TX 71) and the clock (CLK) transmitted from the reception apparatus (reception LSI) 12h are superimposed. The filter 44d transmits the separated external data (SDA) to the I2C RCV13.

The transmission apparatus (CIS) 11i includes a first transmission pattern cancel filter 47b, and the first transmission pattern cancel filter 47b includes a first inverse pattern generation unit 45b and a first mixer 46b. The first inverse pattern generation unit 45b generates a first inverse pattern having a waveform opposite to a waveform of the retention data (DATA). A first mixer 46b mixes the generated first inverse pattern with the signal in which the external data (SDA) transmitted from the external apparatus (I2C TX 71), the clock (CLK) transmitted from the reception apparatus (reception LSI) 12h, and the retention data (DATA) are superimposed, cancels the waveform of the retention data (DATA) from the signal in which the external data (SDA) transmitted from the external apparatus (I2C TX 71), the clock (CLK) transmitted from the reception apparatus (reception LSI) 12h, and the retention data (DATA) are superimposed to separate the clock (CLK) transmitted from the reception apparatus (reception LSI) 12h and the external data (SDA). In this way, the first transmission pattern cancel filter 47b can separate the clock (CLK) transmitted from the reception apparatus (reception LSI) 12h and the external data (SDA).

Note that in a case where the first transmission pattern cancel filter 47b can acquire the differential signal of the retention data (DATA), the first mixer 46b may mix the differential signal of the retention data (DATA) with the signal in which the external data (SDA) transmitted from the external apparatus (I2C TX 71), the clock (CLK) transmitted from the reception apparatus (reception LSI) 12i, and the retention data (DATA) are superimposed, cancel the waveform of the retention data (DATA) from the signal in which the external data (SDA) transmitted from the external apparatus (I2C TX 71), the clock (CLK) transmitted from the reception apparatus (reception LSI) 12e, and the retention data (DATA) are superimposed to separate the clock (CLK) and the external data (SDA) transmitted from the reception apparatus (reception LSI) 12e. In this case, even if the first inverse pattern generation unit 45b is not provided, the first transmission pattern cancel filter 47b can integrally realize the processing of separating the clock (CLK) and the external data (SDA).

### 15. Fourteenth Embodiment (Example of Transmission System 14

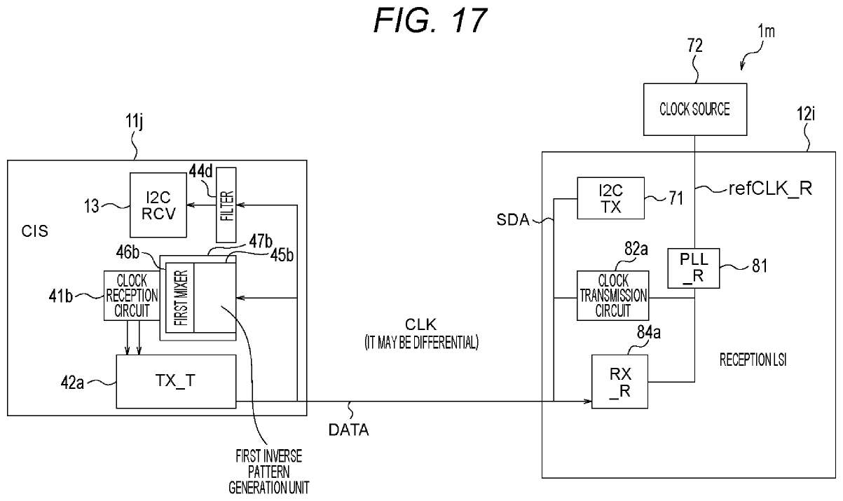

FIG. 17 illustrates a transmission system 1m that is an example of a transmission system according to a fourteenth embodiment of the present technology. FIG. 17 is a block diagram illustrating a configuration example of a transmission system 1m to which the present technology is applied. Note that unless otherwise specified, “upper” means an upper direction in FIG. 17, and “lower” means a lower direction in FIG. 17. In addition, components common to those of the above-described transmission system 1 to 1l are denoted by the same reference numerals, and description thereof will be omitted as appropriate.

As illustrated in FIG. 17, the transmission system 1m according to the fourteenth embodiment of the present technology is configured to incorporate a location (circuit) at which the signals are superimposed or a location (or circuit) at which a signal is branched and wired into a transmission apparatus (CIS) 11j or a reception apparatus (reception LSI) 12i.

The transmission system 1m of the fourteenth embodiment is different from the transmission system 1l of the thirteenth embodiment in that the reception apparatus (reception LSI) 12i superimposes the external data (SDA), the clock (CLK), and the retention data (DATA), and the transmission apparatus (CIS) 11j branches the signal in which the external data (SDA), the clock (CLK), and the retention data (DATA) are superimposed.

As described above, in the transmission system 1m of the fourteenth embodiment, the location (or circuit) at which the signals are superimposed or the location (or circuit) at which the signals are branched and wired can be provided in the transmission apparatus (CIS) 11j or the reception apparatus (reception LSI) 12i.

### 16. Fifteenth Embodiment (Example of Transmission System 15

A transmission system of a first embodiment according to the present technology includes a transmission apparatus and a reception apparatus. A reception apparatus includes a second transmission circuit and a second reception circuit. The second transmission circuit transmits a clock to the transmission apparatus, and the second reception circuit receives retention data retained by the transmission apparatus. A transmission apparatus includes a first reception circuit and a first transmission circuit, and the first reception circuit receives a clock from the reception apparatus, and the first transmission circuit transmits data retained by the first transmission circuit to the reception apparatus using the received clock.

According to the transmission system of the fifteenth embodiment of the present technology, since the transmission apparatus does not include the oscillation circuit, it is possible to further reduce the size, the power, the noise, and the error rate of the transmission apparatus.

FIG. 18 illustrates a transmission system 1n that is an example of a transmission system according to a fifteenth embodiment of the present technology. FIG. 18 is a block diagram illustrating a configuration example of a transmission system to which the present technology is applied. Note that unless otherwise specified, “upper” means an upper direction in FIG. 18, and “lower” means a lower direction in FIG. 18. In addition, components common to those of the above-described transmission system 1 to 1m are denoted by the same reference numerals, and description thereof will be omitted as appropriate.

The transmission system 1n illustrated in FIG. 18 includes a transmission apparatus (CIS) 11k, a reception apparatus (reception LSI) 12k, an external apparatus (I2C TX 71), and a clock source 72. The transmission apparatus (CIS) 11k and the reception apparatus (reception LSI) 12k are realized by different LSIs, for example, and are provided in the same device that processes information, such as a digital camera, a mobile phone, or a personal computer.

In the example of FIG. 18, the transmission apparatus (CIS) 11k and the reception apparatus (reception LSI) 12k are connected via four transmission paths C1 to C4. The transmission paths C1 to C4 may be wired transmission paths or wireless transmission paths. Furthermore, the number of transmission paths between the transmission apparatus (CIS) 11k and the reception apparatus (reception LSI) 12k can be a predetermined number of 5 or more.

A configuration of the transmission apparatus (CIS) 11k will be described. The transmission apparatus (CIS) 11k includes an I2C RCV 13, a first reception circuit (clock reception circuit) 41, a signal processing unit 21, and a first transmission circuit (TX_T) 42.

The I2C RCV 13 receives external data (SDA) transmitted from an external apparatus (I2C TX 71) and a serial clock line (SCL).

The first reception circuit (RX_T) 41 receives clocks (CLK and CLKB) from a second transmission circuit (clock transmission circuit) 82 of the reception apparatus (reception LSI) 12k. Note that the clocks (CLK and CLKB) are not limited to the differential clock, and may be a single-phase clock.

The signal processing unit 21 performs various types of signal processing, and outputs transmission data (retention data), which is data to be transmitted, such as image data, text data, or audio data obtained by performing the signal processing, to the first transmission circuit (TX_T) 42. Note that the transmission data may be a captured image captured by an imaging unit included in the transmission apparatus (CIS) 11k. In addition, the transmission data includes retention data (DATA) retained by the first transmission circuit (TX_T) 42.

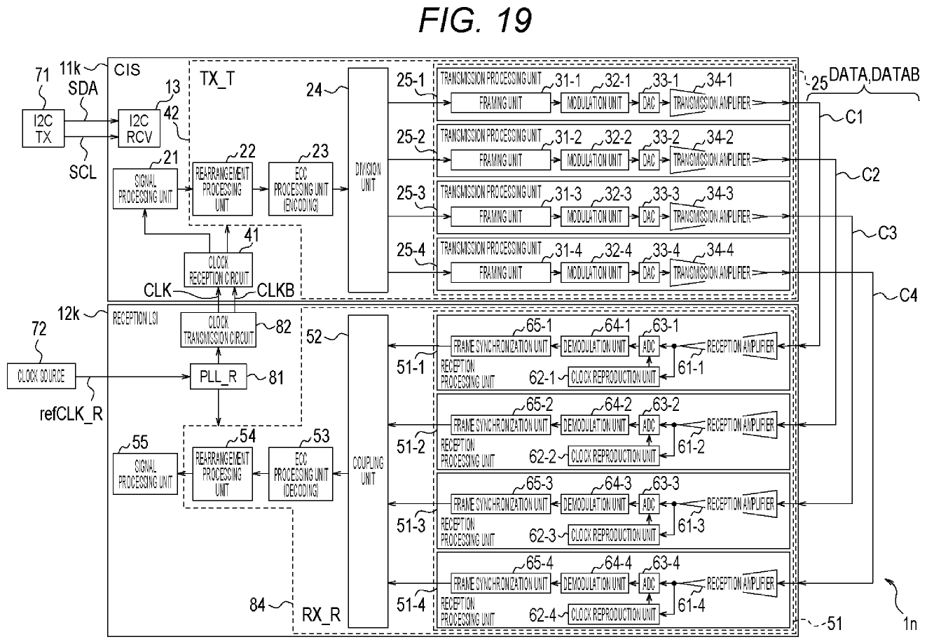

The first transmission circuit (TX_T) 42 includes a transmitting unit 25 (a plurality of transmission processing units 25-1 to 25-4 illustrated in FIG. 19), and the transmitting unit 25 (each of the plurality of transmission processing units 25-1 to 25-4 illustrated in FIG. 19) transmits the retention data (transmission data) retained by the transmission apparatus (CIS) 11k to the reception apparatus (reception LSI) 12k using the received clock.

Furthermore, the first transmission circuit (TX_T) 42 includes a rearrangement processing unit 22 as a first conversion unit, an ECC processing unit 23 as a correction coding calculation unit, a division unit 24, and a transmitting unit 25. Note that the rearrangement processing unit 22, the ECC processing unit 23, the division unit 24, and the transmitting unit 25 will be described in detail with reference to FIG. 19.

A configuration of the reception apparatus (reception LSI) 12k will be described. The reception apparatus (reception LSI) 12k includes a PLL_R 81, a second transmission circuit (TX_R) 82, a second reception circuit (RX_R) 84, and a signal processing unit 55.

The PLL_R 81 receives the reference clock refCLK_R from the clock source 72. The PLL_R 81 supplies the received reference clock refCLK_R to the second transmission circuit (clock transmission circuit) 82 and the second reception circuit (RX_R) 84.

The second reception circuit (RX_R) 84 can include a delay circuit, a delay circuit with calibration, a clock and data recovery circuit, and the like, and can align phases of data received by the second reception circuit (RX_R) 84.

The second reception circuit (RX_R) 84 includes a receiving unit 51 (a plurality of reception processing units 51-1 to 51-4 illustrated in FIG. 19), and the receiving unit 51 (each of the plurality of reception processing units 51-1 to 51-4 illustrated in FIG. 19) receives the retention data (DATA and DATAB) transmitted from the transmission apparatus (transmission-side block) 11k corresponding to each of the transmission paths (transmission paths C1 to C4).

Furthermore, the second reception circuit (RX_R) 84 includes a receiving unit 51, a coupling unit 52, an ECC processing unit 53 as an error correction unit, and a rearrangement processing unit 54 as a second conversion unit. Note that the receiving unit 51, the coupling unit 52, the ECC processing unit 53, and the rearrangement processing unit 54 will be described in detail with reference to FIG. 19.

The signal processing unit 55 performs various types of processing using the retention data (DATA and DATAB) transmitted from the second reception circuit (RX_R) 84. For example, in a case where the retention data (DATA and DATAB) is pixel data constituting an image, in the signal processing unit 55, an image of one frame is generated based on the pixel data, and various processes such as compression of the image data, display of the image, and recording of the image data on a recording medium are performed.

With such a configuration, the transmission system 1n transmits the clocks (CLK and CLKB) from the reception apparatus (reception LSI) 12k to the transmission apparatus (CIS) 11k. In the transmission apparatus (CIS) 11k, the first reception circuit (clock reception circuit) 41 receives the clocks (CLK and CLKB) from the reception apparatus (reception LSI) 12k, and the first transmission circuit (TX_T) 42 of the transmission apparatus (CIS) 11k transmits the retention data retained by the transmission apparatus (transmission side block) 11 to the reception apparatus (reception side block) 12 using the received clock.

In this case, the transmission apparatus (CIS) 11k can drive at least one of the first transmission circuit (TX_T) 42 or the internal circuit (For example, the signal processing unit 21 and the like) without changing the operation frequency of the received clock.

As described above, in the transmission system 1n of the fifteenth embodiment according to the present technology, the transmission apparatus (CIS) 11k operates at the same clock as the reception apparatus (reception LSI) 12k without mounting the oscillation circuit, and can realize a low error rate, so it is possible to reduce design evaluation resources for PLL design and the IP cost for purchasing the IP.

Although the second transmission circuit (clock transmission circuit) 82 transmits the differential clocks (CLK and CLKB), the clock to be transmitted is not limited to the differential clocks (CLK and CLKB), and may be a single-phase clock.

Note that, in a case where the single-phase clock is applied, a potential difference between the transmission apparatus (CIS) 11k and the reception apparatus (reception LSI) 12k may cause jitter. Therefore, for example, grounding of the transmission apparatus (CIS) 11k and the reception apparatus (reception LSI) 12k is made common, or resistance is reduced, or alternating currents of the transmission apparatus (CIS) 11k and the reception apparatus (reception LSI) 12k are AC-coupled. Furthermore, since the ground values of the transmission apparatus (CIS) 11k and the reception apparatus (reception LSI) 12k may be different from each other, AC coupling is performed. Alternatively, since it is also assumed that thresholds of the transmission apparatus (CIS) 11k and the reception apparatus (reception LSI) 12k are different from each other, the AC coupling is performed.

In this case, when the positive and negative balance of the signal is not taken, the signal may be biased to either “H” or “L”. To avoid this, it is preferable to perform 8B10B or Manchester coding.

Next, FIG. 19 illustrates details of the first transmission circuit (TX_T) 42 and the second reception circuit (RX_R) 84 in the transmission system 1n according to the fifteenth embodiment of the present technology. FIG. 19 is a block diagram illustrating details of the first transmission circuit (TX_T) 42 and the second reception circuit (RX_R) 84 in the transmission system 1n of the fifteenth embodiment according to the present technology.

Note that unless otherwise specified, “upper” means an upper direction in FIG. 19, and “lower” means a lower direction in FIG. 19. In addition, components common to those of the transmission system 1n illustrated in FIG. 18 are denoted by the same reference numerals, and description thereof will be omitted as appropriate.

The configuration of the first transmission circuit (TX_T) 42 will be described with reference to FIG. 19. The first transmission circuit (TX_T) 42 includes a rearrangement processing unit 22, an ECC processing unit 23, a division unit 24, and transmission processing units 25-1 to 25-4.

The transmission processing unit 25-1 includes a framing unit 31-1, a modulation unit 32-1, a DAC 33-1, and a transmission amplifier 34-1, and the transmission processing unit 25-2 includes a framing unit 31-2, a modulation unit 32-2, a DAC 33-2, and a transmission amplifier 34-2. The transmission processing unit 25-3 includes a framing unit 31-3, a modulation unit 32-3, a DAC 33-3, and a transmission amplifier 34-3, and the transmission processing unit 25-4 includes a framing unit 31-4, a modulation unit 32-4, a DAC 33-4, and a transmission amplifier 34-4.

As described above, in the transmission apparatus (CIS) 11k, if a configuration close to the transmission path is a lower configuration, the division unit 24 is provided at positions lower than the ECC processing unit 23. In addition, the framing units 31-1 to 31-4, the modulation units 32-1 to 32-4, and the DACs 33-1 to 33-4, and the transmission processing unit 25 (25-1 to 25-4) having transmission amplifiers 34-1 to 34-4 are provided at positions lower than the division unit 24, corresponding to the transmission paths C1 to C4.

Note that the transmission apparatus (CIS) 11k can input data from an external circuit to the rearrangement processing unit 22. For example, pixel data constituting an image captured by an external image sensor such as complementary metal oxide semiconductor (CMOS) may be input as transmission data one by one in order.

The rearrangement processing unit 22 acquires the retention data (transmission data) supplied from the signal processing unit 21 and rearranges the acquired retention data (transmission data). For example, in a case where the retention data (transmission data) is data constituting one symbol with a predetermined number of bits such as 12 bits, the rearrangement processing unit 22 rearranges data to convert the data into data in units of 8 bits. For example, the signal processing unit 21 performs addition processing on the retention data (transmission data) using the received clock, and the rearrangement processing unit 22 converts the data subjected to the addition processing into units constituting a predetermined symbol.

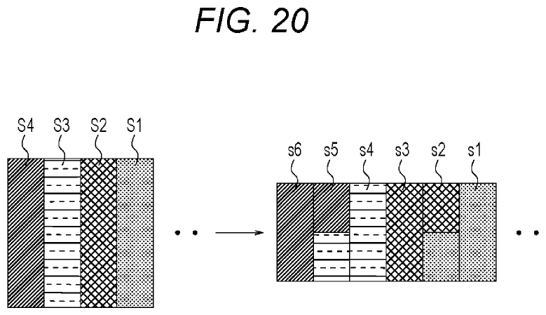

FIG. 20 is a diagram illustrating an example of rearrangement of the retention data (transmission data).

Four vertically long blocks illustrated on the left side of FIG. 20 represent symbols S1 to S4 that are 12 bit data, respectively. A longitudinal length of each block represents 12 bits.

For example, in a case where the symbols S1 to S4 are input as the retention data (transmission data), in the rearrangement processing unit 22, 8 bits are collected in the input order and rearranged into symbols s1 to s6 which are data in units of 8 bits as indicated by an arrow.

The symbol s1 includes eight bits from a first bit to an eighth bit of the symbol S1. The symbol s2 includes 8 bits including 4 bits from a ninth bit to a twelfth bit of the symbol S1 and 4 bits from the first bit to the fourth bit of the symbol S2. The symbol s3 includes 8 bits from the fifth bit to the twelfth bit of the symbol S2. The symbol s4 includes eight bits from the first bit to the eighth bit of the symbol S3. The symbol s5 includes 8 bits including 4 bits from the ninth bit to the twelfth bit of the symbol S3 and 4 bits from the first bit to the fourth bit of the symbol S4. The symbol s6 includes 8 bits from the fifth bit to the twelfth bit of the symbol S4.

Each symbol constituting the retention data (transmission data) may be represented by the number of bits other than 12 bits. In the rearrangement processing unit 22, even when each symbol of the retention data (transmission data) is represented by any number of bits, processing of re-dividing the retention data (transmission data) into data in units of 8 bits is performed so that a transmission frame can be generated by the same processing in a processing unit at a subsequent stage. The rearrangement processing unit 22 outputs the transmission data in units of 8 bits obtained by performing the rearrangement to the ECC processing unit 23.

The error correcting code (ECC) processing unit 23 calculates an error correction code used for error correction of the retention data (transmission data) based on the retention data (transmission data) in units of 8 bits supplied from the rearrangement processing unit 22. In addition, the ECC processing unit 23 performs error correction coding by adding parity that is an error correction code obtained by calculation to the transmission data. For example, a Reed Solomon code is used as the error correction code.

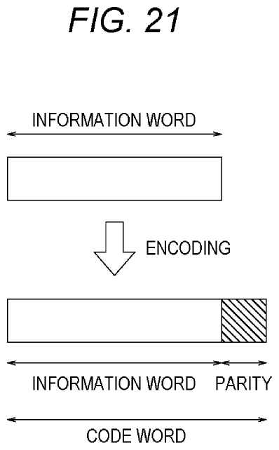

FIG. 21 is a diagram illustrating an example of the error correction coding by the ECC processing unit 23.

The ECC processing unit 23 applies a predetermined number of transmission data in units of 8 bits as an information word to a generator polynomial and calculates parity. For example, the parity obtained by the ECC processing unit 23 is also data in units of 8 bits. As indicated by an outline arrow, the ECC processing unit 23 adds the parity obtained by calculation to the information word to generate a code word. The ECC processing unit 23 outputs encoded data that is data of the generated code word to the division unit 24 in units of 8 bits.

The division unit 24 performs transmission path division by allocating the encoded data in units of 8 bits supplied from the ECC processing unit 23 to each of the transmission paths C1 to C4 in order from the head data. When certain encoded data is allocated to the transmission path C4, the division unit 24 performs transmission path division so as to sequentially allocate subsequent encoded data to each of the transmission paths subsequent to the transmission path C1.

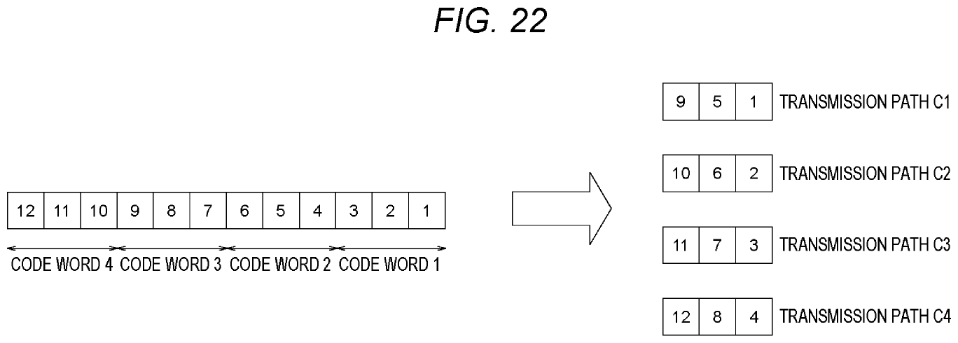

FIG. 22 is a diagram illustrating an example of the transmission path division.

Each block denoted by a number represents transmission data or parity in units of 8 bits. A case where one code word is configured from 24 bit data of each of blocks 1 to 3, blocks 4 to 6, blocks 7 to 9, and blocks 10 to 12, and the encoded data of the blocks 1 to 12 is sequentially supplied will be described.

In this case, the division unit 24 allocates the encoded data supplied from the ECC processing unit 23 to the transmission paths C1 to C4 in the order of supply so that the encoded data constituting the same code word is not transmitted using the same transmission path. In the example of FIG. 22, the encoded data of the blocks 1, 2, and 3 constituting the code word 1 is allocated to the transmission paths C1, C2, and C3, respectively, and the encoded data of the blocks 4, 5, and 6 constituting the code word 2 is allocated to the transmission paths C4, C1, and C2, respectively. The encoded data of the blocks 7, 8, and 9 constituting the code word 3 is allocated to the transmission paths C3, C4, and C1, respectively, and the encoded data of the blocks 10, 11, and 12 constituting the code word 4 is allocated to the transmission paths C2, C3, and C4, respectively.

The encoded data of the blocks 1, 5, and 9 allocated to the transmission path C1 is supplied to the framing unit 31-1 in that order, and the encoded data of the blocks 2, 6, and 10 allocated to the transmission path C2 is supplied to the framing unit 31-2 in that order. The encoded data of the blocks 3, 7, and 11 allocated to the transmission path C3 is supplied to the framing unit 31-3 in that order, and the encoded data of the blocks 4, 8, and 12 allocated to the transmission path C4 is supplied to the framing unit 31-4 in that order.

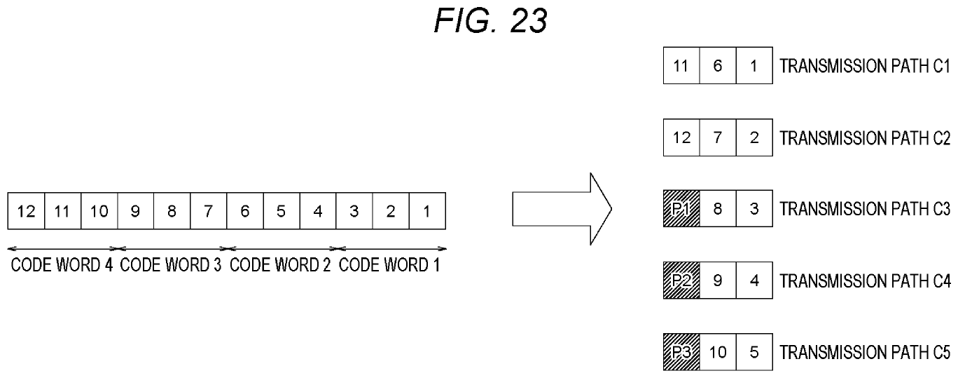

FIG. 23 is a diagram illustrating another example of the transmission path division.

A case where the blocks 1 to 12 described in FIG. 22 are allocated to five transmission paths C1 to C5 will be described with reference to FIG. 23. The transmission path division illustrated in FIG. 23 is performed when the transmission apparatus (CIS) 11k and the reception apparatus (reception LSI) 12k are connected by five transmission paths.

In this case, similarly, the division unit 24 allocates the encoded data supplied from the ECC processing unit 23 to the transmission paths C1 to C5 in the order of supply so that the encoded data constituting the same code word is not transmitted using the same transmission path. In the example of FIG. 23, the encoded data of the blocks 1, 2, and 3 constituting code word 1 is allocated to the transmission paths C1, C2, and C3, respectively, and the encoded data of the blocks 4, 5, and 6 constituting code word 2 is allocated to the transmission paths C4, C5, and C1, respectively. The encoded data of the blocks 7, 8, and 9 constituting the code word 3 is allocated to the transmission paths C2, C3, and C4, respectively, and the encoded data of the blocks 10, 11, and 12 constituting the code word 4 is allocated to the transmission paths C5, C1, and C2, respectively.

After allocating all the encoded data to each of the transmission paths, the division unit 24 allocates padding data to the transmission path having a small allocation amount of the encoded data so that the data amount of the encoded data allocated to each of the transmission paths becomes the same amount. The padding data is 8-bit data and has a predetermined value such as “00000000”.

In the example of FIG. 23, the padding data is allocated one by one to transmission paths C3, C4, and C5 which are transmission paths having a small data amount of the allocated encoded data. In FIG. 23, hatched blocks represent the padding data.

The encoded data of the blocks 1, 6, and 11 allocated to the transmission path C1 is supplied to the framing unit 31-1 in that order, and the encoded data of the blocks 2, 7, and 12 allocated to the transmission path C2 is supplied to the framing unit 31-2 in that order. The blocks 3 and 8 allocated to the transmission path C3 and the padding data P1 allocated to the transmission path C3 following the encoded data of the block 8 are supplied to the framing unit 31-3 in that order. The blocks 4 and 9 allocated to the transmission path C4 and the padding data P2 allocated to the transmission path C4 following the encoded data of the block 9 are supplied to the framing unit 31-4 in that order. The blocks 5 and 10 allocated to the transmission path C5 and the padding data P3 allocated to the transmission path C5 following the encoded data of the block 10 are supplied to a transmission processing unit (not illustrated) that processes data transmitted via the transmission path C5 in that order.

As described above, in a case where the data amount of the encoded data allocated to each transmission path is different, the padding data is allocated by the division unit 24. The number (number of bytes) of the entire padding data to be allocated is a number obtained by subtracting a remainder obtained by dividing the number of encoded data by the number of transmission paths by the number of transmission paths. The data allocated to each transmission path has the same size, so the processes performed in parallel in the transmission processing units 25-1 to 25-4 can be synchronized.

The framing unit 31-1 of the transmission processing unit 25-1 stores the encoded data supplied from the division unit 24 in a payload, and generates a packet by adding a header and a footer including information on the transmission data. In a case where the padding data is allocated to the transmission path C1, in the framing unit 31-1, the padding data is also stored in the payload of the packet similarly to the encoded data.

Further, the framing unit 31-1 generates the transmission frame by adding a start code indicating a start position of the packet data to a head of the packet and adding an end code indicating an end position of the packet data to a tail of the packet.

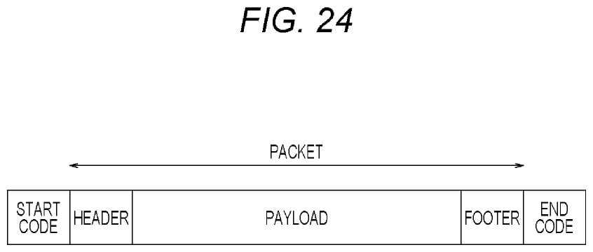

FIG. 24 is a diagram illustrating a frame configuration of a transmission frame.

As illustrated in FIG. 24, one packet is configured by adding the header and the footer to the payload in which the encoded data is stored. In addition, the transmission frame is configured by adding the start code and the end code to the packet.

The framing unit 31-1 outputs frame data, which is data of a transmission frame having a frame configuration as illustrated in FIG. 24, to the modulation unit 32-1 in order from head data.

The modulation unit 32-1 modulates the frame data supplied from the framing unit 31-1 by a predetermined method, and outputs the modulated frame data to the DAC 33-1.

The digital analog converter (DAC) 33-1 performs D/A conversion on the frame data supplied from the modulation unit 32-1 and outputs an analog signal obtained by performing the D/A conversion to the transmission amplifier 34-1.

The transmission amplifier 34-1 adjusts a signal voltage of the signal supplied from the DAC 33-1, and transmits the adjusted signal to the reception side block 12 via the transmission path C1.

Also in the transmission processing units 25-2 to 25-4, processing similar to the processing performed in each unit of the transmission processing unit 25-1 is performed. That is, in the transmission processing unit 25-2, the encoded data allocated to the transmission path C2 is subjected to the framing, the modulation, and the D/A conversion, and a signal representing the frame data is transmitted via the transmission path C2. In addition, the transmission processing unit 25-3 performs the framing, the modulation, and the D/A conversion on the encoded data allocated to the transmission path C3, and transmits a signal representing the frame data via the transmission path C3. The transmission processing unit 25-4 performs the framing, the modulation, and the D/A conversion on the encoded data allocated to the transmission path C4, and transmits a signal representing the frame data via the transmission path C4.

Next, a configuration of the second reception circuit (RX_R) 84 will be described. The second reception circuit (RX_R) 84 includes reception processing units 51-1 to 51-4, a coupling unit 52, an ECC processing unit 53, and a rearrangement processing unit 54.

The reception processing unit 51-1 (FIG. 19) includes a reception amplifier 61-1, a clock reproduction unit 62-1, an analog digital converter (ADC) 63-1, a demodulation unit 64-1, and a frame synchronization unit 65-1. The reception processing unit 51-2 includes a reception amplifier 61-2, a clock reproduction unit 62-2, an ADC 63-2, a demodulation unit 64-2, and a frame synchronization unit 65-2. The reception processing unit 51-3 includes a reception amplifier 61-3, a clock reproduction unit 62-3, an ADC 63-3, a demodulation unit 64-3, and a frame synchronization unit 65-3. The reception processing unit 51-4 includes a reception amplifier 61-4, a clock reproduction unit 62-4, an ADC 63-4, a demodulation unit 64-4, and a frame synchronization unit 65-4.

A signal transmitted from the transmission amplifier 34-1 of the transmission apparatus (CIS) 11k is input to the reception amplifier 61-1, and a signal transmitted from the transmission amplifier 34-2 is input to the reception amplifier 61-2. The signal transmitted from the transmission amplifier 34-3 is input to the reception amplifier 61-3, and the signal transmitted from the transmission amplifier 34-4 is input to the reception amplifier 61-4.

As described above, in the reception apparatus (reception LSI) 12k, when the configuration close to the transmission path is a lower configuration, the coupling unit 52 is provided at positions lower than the ECC processing unit 53. Furthermore, the reception processing unit 51 (51-1 to 51-4) that includes the reception amplifiers 61-1 to 61-4, the clock reproduction units 62-1 to 62-4, the ADCs 63-1 to 63-4, the demodulation units 64-1 to 64-4, and the frame synchronization units 65-1 to 65-4 are provided at positions lower than the coupling unit 52, corresponding to the transmission paths C1 to C4.

The reception amplifier 61-1 of the reception processing unit 51-1 receives the signal transmitted from the transmission apparatus (CIS) 11k, adjusts the signal voltage, and outputs the adjusted signal voltage. The signal output from the reception amplifier 61-1 is input to the clock reproduction unit 62-1 and the ADC 63-1.

The clock reproduction unit 62-1 performs bit synchronization by detecting the edge of the input signal, and recovers the clock signal based on the detection cycle of the edge. The clock reproduction unit 62-1 outputs the reproduced clock signal to the ADC 63-1.

The ADC 63-1 samples the input signal according to the clock signal reproduced by the clock reproduction unit 62-1, and outputs frame data obtained by the sampling to the demodulation unit 64-1.

The demodulation unit 64-1 demodulates the frame data by a method corresponding to the modulation method in the modulation unit 32-1 of the transmission side block 11, and outputs the demodulated frame data to the frame synchronization unit 65-1.

The frame synchronization unit 65-1 detects the start code and the end code from the frame data supplied from the demodulation unit 64-1 and performs the frame synchronization. The frame synchronization unit 65-1 detects data from the start code to the end code as packet data, and outputs the encoded data stored in the payload to the coupling unit 52.

Also in the reception processing units 51-2 to 51-4, processing similar to the processing performed in each unit of the reception processing unit 51-1 is performed. That is, in the reception processing unit 51-2, the sampling of the signal transmitted via the transmission path C2, the demodulation of the frame data obtained by the sampling, and the frame synchronization processing are performed, and the encoded data is output to the coupling unit 52. In the reception processing unit 51-3, the sampling of the signal transmitted via the transmission path C3, the demodulation of the frame data obtained by the sampling, and the frame synchronization processing are performed, and the encoded data is output to the coupling unit 52. In the reception processing unit 51-4, the sampling of the signal transmitted via the transmission path C4, the demodulation of the frame data obtained by the sampling, and the frame synchronization processing are performed, and the encoded data is output to the coupling unit 52.

The coupling unit 52 performs the transmission path coupling (integration) by rearranging the encoded data supplied from the reception processing units 51-1 to 51-4 in the reverse order to the allocation order to the respective transmission paths by the division unit 24 of the transmission apparatus (CIS) 11k.

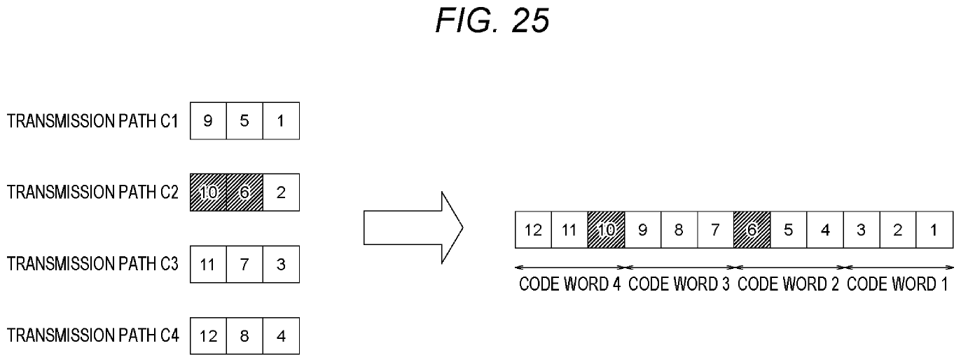

FIG. 25 is a diagram illustrating an example of the transmission path coupling of the retention data (transmission data).

It is assumed that the transmission path division of the encoded data of the blocks 1 to 12 is performed as described in FIG. 22. In this case, the coupling unit 52 rearranges the encoded data in the reverse order to the order of the allocation to the respective transmission paths at the time of transmission path division, and generates the encoded data in the same order as the order of output from the ECC processing unit 23 as indicated by an outlined arrow in FIG. 25. The coupling unit 52 sequentially outputs the encoded data of the blocks 1 to 12 constituting the respective code words generated by the rearrangement to the ECC processing unit 53.

In a case where the padding data is supplied from the reception processing units 51-1 to 51-4 following the encoded data, the coupling unit 52 removes the padding data and outputs only the encoded data.

The ECC processing unit 53 detects an error in the transmission data by performing an error correction operation based on the parity included in the encoded data supplied from the coupling unit 52 and corrects the detected error.

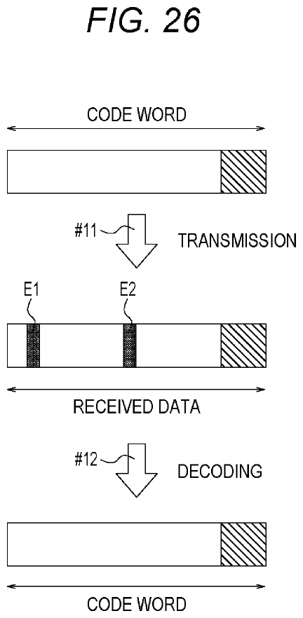

FIG. 26 is a diagram illustrating an example of the error correction decoding by the ECC processing unit 53.

For example, a case where data of a code word illustrated in the upper part of FIG. 26 is transmitted as encoded data from the transmission apparatus (CIS) 11k, and data as indicated by a point of an outlined arrow #11 is received will be described. Bits E1 and E2 in the received data of FIG. 26 represent erroneous bits.

In this case, in the ECC processing unit 53, the bits E1 and E2 are detected by performing the error correction calculation based on the parity, and are corrected as indicated by a portion pointed by an outlined arrow #12. The ECC processing unit 53 performs error correction decoding on each code word and outputs the transmission data after the error correction to the rearrangement processing unit 54.

The rearrangement processing unit 54 rearranges the transmission data in units of 8 bits supplied from the ECC processing unit 53 in the reverse order to the rearrangement order by the rearrangement processing unit 22 of the transmission apparatus (CIS) 11k. That is, in the rearrangement processing unit 54, by performing the reverse processing to the processing described with reference to FIG. 20, the transmission data in units of 8 bits is converted into the transmission data in units of a predetermined number of bits such as 12 bits. The rearrangement processing unit 54 outputs the transmission data obtained by performing the rearrangement to the signal processing unit 55.

The signal processing unit 55 performs various types of processing using the transmission data supplied from the rearrangement processing unit 54. For example, in a case where the transmission data is pixel data constituting an image, in the signal processing unit 55, an image of one frame is generated based on the pixel data, and various processing such as compression of the image data, display of the image, and recording of the image data on a recording medium are performed.

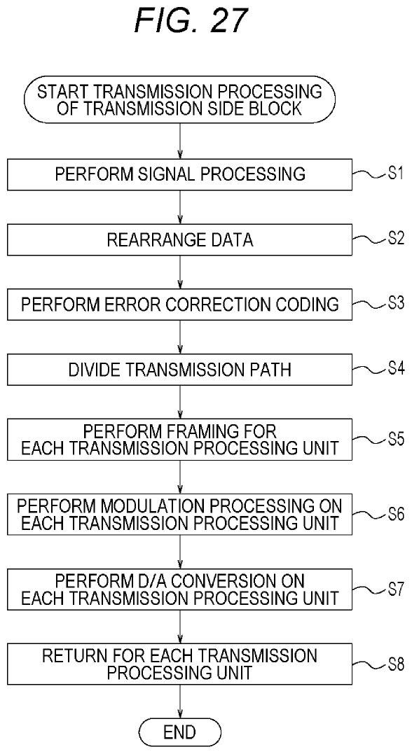

Next, a series of processes of the transmission apparatus (CIS) 11k and the reception apparatus (reception LSI) 12k will be described. First, the transmission processing of the transmission apparatus (CIS) 11k will be described with reference to the flowchart in FIG. 27.

In step S1, the signal processing unit 21 performs signal processing and outputs retention data (transmission data) obtained by performing the signal processing.

In step S2, the rearrangement processing unit 22 acquires the retention data (transmission data) supplied from the signal processing unit 21, and rearranges the data as described with reference to FIG. 20.

In step S3, the ECC processing unit 23 performs error correction coding by calculating parity based on the transmission data in units of 8 bits obtained by the rearrangement and adding the parity to the transmission data.

In step S4, the division unit 24 performs the transmission path division of the encoded data obtained by the error correction coding. The processing in steps S5 to S8 is performed in parallel in the transmission processing units 25-1 to 25-4.

That is, in step S5, each of the framing units 31-1 to 31-4 stores the encoded data obtained by the error correction encoding in the payload, and generates a packet by adding the header and the footer. Furthermore, the framing units 31-1 to 31-4 perform framing by adding the start code to the head of the packet and adding the end code to the tail.

In step S6, each of the modulation units 32-1 to 32-4 performs the modulation processing on frame data constituting the transmission frame obtained by the framing.

In step S7, each of the DACs 33-1 to 33-4 performs D/A conversion on the frame data obtained by performing the modulation processing.

In step S8, each of the transmission amplifiers 34-1 to 34-4 transmits the signal obtained by the D/A conversion to the reception apparatus (reception LSI) 12k. The processes of steps S2 to S8 are repeatedly performed for all the retention data (transmission data) output from the signal processing unit 21, and are ended when the processing for all the retention data (transmission data) is ended.

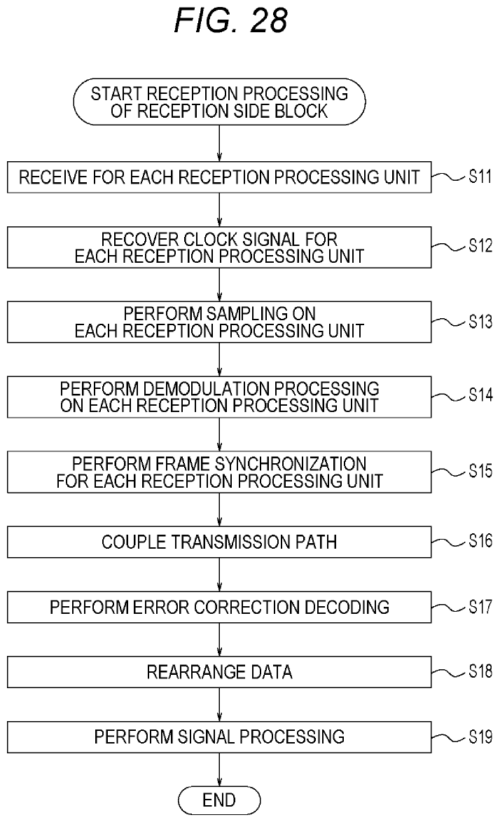

Next, the reception processing of the reception apparatus (reception LSI) 12k will be described with reference to the flowchart of FIG. 28.

The processes of steps S11 to S15 are performed in parallel in the reception processing units 51-1 to 51-4. That is, in step S11, each of the reception amplifiers 61-1 to 61-4 receives the retention data (transmission data) transmitted from the transmission apparatus (CIS) 11k and adjusts the signal voltage.

In step S12, the clock reproduction units 62-1 to 62-4 detect the edges of the signals supplied from the reception amplifiers 61-1 to 61-4, respectively, and regenerate the clock signals.

In step S13, the ADCs 63-1 to 63-4 perform sampling according to the clock signals reproduced by the clock reproduction units 62-1 to 62-4.

In step S14, the demodulation units 64-1 to 64-4 perform the demodulation processing on the frame data obtained by the sampling.

In step S15, the frame synchronization units 65-1 to 65-4 perform the frame synchronization by detecting the start code and the end code from the frame data supplied from the demodulation units 64-1 to 64-4. The frame synchronization units 65-1 to 65-4 output the encoded data stored in the payload to the coupling unit 52.

In step S16, the coupling unit 52 performs the transmission path coupling by rearranging the encoded data supplied from the frame synchronization units 65-1 to 65-4 in the reverse order to the order of the allocation to the respective transmission paths at the time of transmission path division.

In step S17, the ECC processing unit 53 performs the error correction decoding based on the parity included in the code word configured by the encoded data and corrects the error of the retention data (transmission data).

In step S18, the rearrangement processing unit 54 rearranges the transmission data after the error correction, and generates the signal of the same predetermined bit number unit as the data output from the signal processing unit 21 in the retention data (transmission data) k. The processes of steps S11 to S18 are repeatedly performed until the processing for the signal transmitted from the transmission apparatus (CIS) 11k is completed.

When the processing for the retention data (transmission data) transmitted from the transmission apparatus (CIS) 11k is completed, the signal processing unit 55 performs the signal processing based on the retention data (transmission data) supplied from the rearrangement processing unit 54 in step S19. When the signal processing is ended, the signal processing unit 55 ends the processing.

As described above, in the transmission system 1n, the error of the retention data (transmission data) generated on the transmission path is corrected using the error correction code added to the transmission data. As a result, it is not necessary to request the transmission apparatus (CIS) 11k to retransmit the retention data (transmission data) when an error occurs in the retention data (transmission data), and thus, it is possible to secure the real-time property of the data transmission while securing the error measure. In addition, since it is not necessary to provide the transmission path for retransmission request, it is possible to simplify the circuit configuration and reduce the cost. Since the circuit configuration can be simplified, power consumption can also be reduced.

Furthermore, high-speed data transmission is enabled by dividing encoded data, performing the processing after the division in parallel, and then transmitting the encoded data in parallel using a plurality of transmission paths.

In addition, by performing the transmission path division/coupling at positions lower than the ECC processing units 23 and 53, it is sufficient to provide one ECC processing unit 23 and one ECC processing unit 53 for each of the transmission apparatus (CIS) 11k and the reception apparatus (reception LSI) 12k, and the circuit scale can be reduced.

For example, in a case where the transmission path division is performed at positions higher than the ECC processing unit 23 that performs the error correction coding, it is necessary to prepare ECC processing units 23, the number of which is the same as the number of transmission paths, and the circuit scale of the transmission apparatus (CIS) 11k becomes large, but such a situation can be prevented. Furthermore, in a case where transmission path coupling is performed at positions higher than the ECC processing unit 53 that performs the error correction decoding, it is necessary to prepare the ECC processing units 53, the number of which is the same as the number of transmission paths, and the circuit scale of the reception apparatus (reception LSI) 12k becomes large, but such a situation can be prevented.

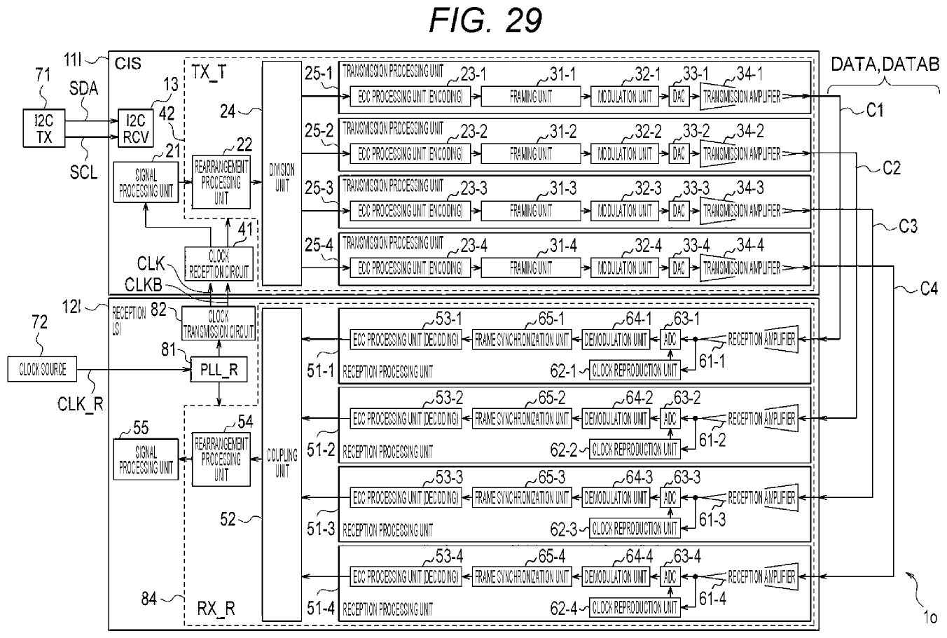

FIG. 29 illustrates a configuration of a transmission apparatus (CIS) 111 that performs error correction coding after the transmission path division and a configuration of a reception apparatus (reception LSI) 121 that performs the error correction decoding before the transmission path coupling. In the transmission apparatus (CIS) 111 of FIG. 29, the ECC processing units 23-1 to 23-4, the number of which is the same as the number of transmission paths, are provided at positions lower than the division unit 24. In addition, the reception apparatus (reception LSI) 121 includes the ECCC processing units 53-1 to 53-4, the number of which is the same as the number of transmission paths, at positions lower than the coupling unit 52.

In addition, the error correction coding is performed before the transmission path division, and the encoded data constituting the same code word is transmitted through different transmission paths, so burst errors (continuous errors) generated in the transmission paths can be dispersed in the decoded code word, and the error correction capability can be improved.

For example, a case where a burst error of 2 bytes occurs in the transmission path C2 as illustrated on the left side of FIG. 25 is considered. The encoded data of the block 6 and the encoded data of the block 10 continuously transmitted on the transmission path C2 are erroneous data. Of the blocks illustrated in FIG. 25, a block with hatching represents a block of encoded data in which an error has occurred, and a block without hatching represents a block of encoded data in which no error has occurred.

In this case, as indicated by an outline arrow, in the encoded data after the transmission path coupling, the encoded data of the block 6 and the encoded data of the block 10 transmitted via the transmission path C2 are dispersed in different code words. In general, many error correction codes are weak against burst errors. For example, in the Reed Solomon code, since the number of errors correctable per code word is determined, if burst errors concentrated on one code word can be dispersed among code words, the error correction capability can be improved.

### 17. Sixteenth Embodiment (Example of Transmission System 16

A transmission system according to a sixteenth embodiment of the present technology is a transmission system in which a first reception circuit receives a single-phase clock in the transmission system according to the fifteenth embodiment. In this case, the reception apparatus transmits the single-phase clock to the transmission apparatus, so the first reception circuit of the transmission apparatus receives the single-phase clock.

According to the transmission system of the sixteenth embodiment of the present technology, when the reception apparatus transmits the single-phase clock, the transmission apparatus can be driven by the received single-phase clock.

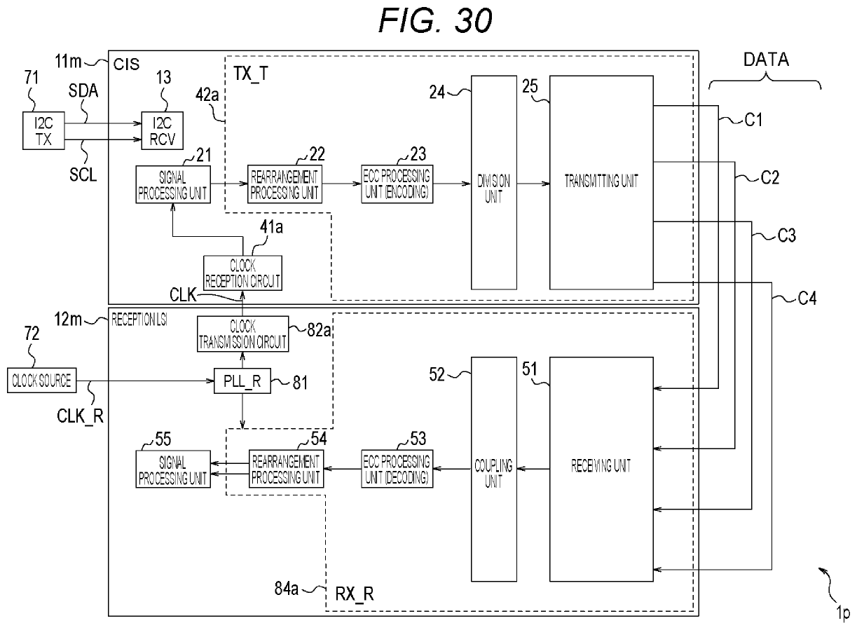

FIG. 30 illustrates a transmission system 1p that is an example of a transmission system according to a sixteenth embodiment of the present technology. FIG. 30 is a block diagram illustrating a configuration example of the transmission system to which the present technology is applied. Note that unless otherwise specified, “upper” means an upper direction in FIG. 30, and “lower” means a lower direction in FIG. 30. In addition, components common to those of the above-described transmission system 1 to 10 are denoted by the same reference numerals, and description thereof will be omitted as appropriate.

The transmission system 1p illustrated in FIG. 30 is different from the transmission system 1n illustrated in FIG. 18 in that a second transmission circuit (clock transmission circuit) 82a of a reception apparatus (reception LSI) 12m transmits a single-phase clock to a transmission apparatus (CIS) 11m. As a result, the first reception circuit (clock reception circuit) 41a of the transmission apparatus (CIS) 11m can receive a single-phase clock. The transmission apparatus (CIS) 11m transmits retention data (DATA) from a first transmission circuit (TX_T) 42a to second reception circuit (RX_R) 84a of a reception apparatus (reception LSI) 12m.

Note that the transmission system 1p according to the sixteenth embodiment of the present technology is a system in which a first transmission circuit (TX_T) 42a, a signal processing unit 21, a second reception circuit (RX_R) 84a, and a signal processing unit 55 are added to the transmission system 1b according to the third embodiment of the present technology illustrated in FIG. 3.

As described above, according to the transmission system 1p of the sixteenth embodiment of the present technology, the reception apparatus (reception LSI) 12m transmits the single-phase clock to the transmission apparatus (CIS) 11m, so the first reception circuit (clock reception circuit) 41a of the transmission apparatus (CIS) 11m receives the single-phase clock. In addition, the first transmission circuit (TX_T) 42a of the transmission apparatus (CIS) 11m transmits the retention data (DATA) in a single phase. In this case, in the transmission system 1p of the embodiment, AC coupling may be performed between the transmission apparatus (CIS) 11m and the reception apparatus (reception LSI) 12m, and 8B10B or Manchester encoding may also be performed.

### 18. Seventeenth Embodiment (Example of Transmission System 17

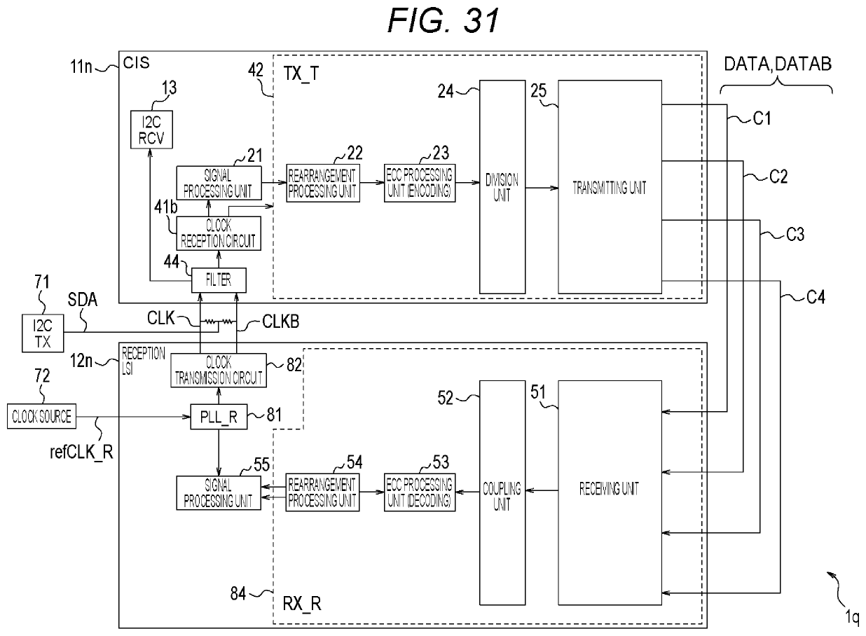

FIG. 31 illustrates a transmission system 1q that is an example of a transmission system according to a seventeenth embodiment of the present technology. FIG. 31 is a block diagram illustrating a configuration example of a transmission system 1q to which the present technology is applied. Note that unless otherwise specified, “upper” means an upper direction in FIG. 31, and “lower” means a lower direction in FIG. 31. In addition, components common to those of the above-described transmission system 1 to 1q are denoted by the same reference numerals, and description thereof will be omitted as appropriate.

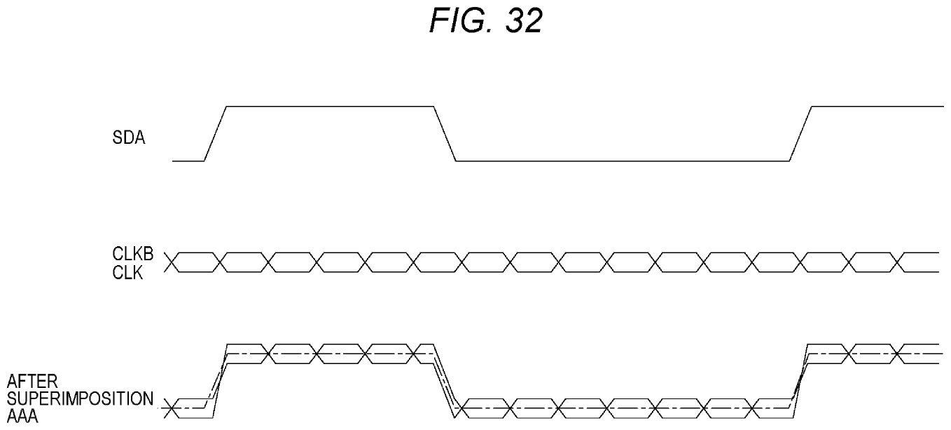

FIG. 32 is a timing chart of the transmission system 1q that is an example of the transmission system according to the seventeenth embodiment of the present technology. FIG. 32 is an explanatory diagram illustrating external data (SDA) transmitted from an external apparatus (I2C TX 71), differential clocks (CLK and CLKB) of a second transmission circuit (clock transmission circuit) 82 of a reception apparatus (reception LSI) 12n, and a superimposed signal AAA in which the external data (SDA) and the clocks (CLK and CLKB) are superimposed.

The transmission system 1q according to a seventeenth embodiment of the present technology is a system in which a first transmission circuit (TX_T) 42, a signal processing unit 21, a second reception circuit (RX_R) 84, and a signal processing unit 55 are added to the transmission system 1c according to the fourth embodiment of the present technology illustrated in FIG. 4.

The transmission system 1q illustrated in FIG. 31 is different from the transmission system 1n illustrated in FIG. 18 in that clocks (CLK and CLKB) transmitted from a second transmission circuit (clock transmission circuit) 82 and external data (SDA) of an external apparatus (I2C TX 71) are vibrated at a differential common level. In the seventeenth embodiment, since the external data (SDA) of the external apparatus (I2C TX 71) is superimposed on the clocks (CLK and CLKB) outside the reception apparatus (reception LSI) 12n, a special mechanism is unnecessary for the reception apparatus (reception LSI) 12n.

As a result, the transmission apparatus (CIS) 11n can receive a differential signal in which the external data (SDA) transmitted from the external apparatus (I2C TX 71) and the clocks (CLK and CLKB) transmitted from the reception apparatus (reception LSI) 12n are superimposed.

The transmission apparatus (CIS) 11n includes the filter 44, and the filter 44 separates the clocks (CLK and CLKB) transmitted from the reception apparatus (reception LSI) 12n from the signal AAA in which the external data (SDA) transmitted from the external apparatus (I2C TX 71) and the clocks (CLK and CLKB) transmitted from the reception apparatus (reception LSI) 12n are superimposed. Further, the filter 44 transmits the separated clocks (CLK and CLKB) to the first reception circuit (clock reception circuit) 41b, and transmits the external data (SDA) to I2CRCV13.

Note that by superimposing the external data (SDA) of the external apparatus (I2C TX 71) on the clocks (CLK and CLKB) during a blanking period, the quality of the superimposed signal AAA is not affected. Therefore, when superimposing the external data (SDA) on the clocks (CLK and CLKB), it is preferable to use the blanking period in which transmission apparatus (CIS) 11c transmits the retention data (DATA and DATA B).

Furthermore, in the transmission system 1q of the seventeenth embodiment, the external data (SDA) of the external apparatus (I2C TX 71) is superimposed on the clocks (CLK and CLKB), but is not limited thereto, and for example, a reference clock refCLK_R and SCL of the external apparatus (I2C TX 71) may be integrated. In this case, the reception apparatus (reception LSI) 12n can use a crystal oscillator of the clock source 72 as a reference by generating the SCL of the external apparatus (I2C TX 71) inside the reception apparatus (reception LSI) 12n, so a jitter difference between the transmission and reception clocks can be reduced.

Note that, in FIG. 31, a circuit that superimposes the external data (SDA) of the external apparatus (I2C TX 71) on the clocks (CLK and CLKB) is arranged outside the reception apparatus (reception LSI) 12n, but the reception apparatus (reception LSI) 12n may include the circuit.

### 19. Eighteenth Embodiment (Example of Transmission System 18

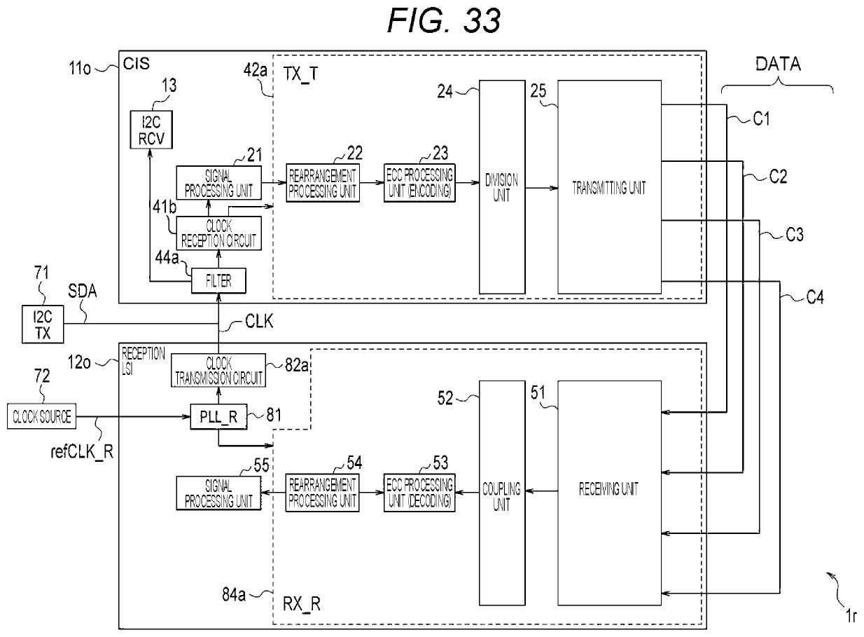

FIG. 33 illustrates a transmission system 1r that is an example of a transmission system according to an eighteenth embodiment of the present technology. FIG. 18 is a block diagram illustrating a configuration example of the transmission system 1r to which the present technology is applied. Note that unless otherwise specified, “upper” means an upper direction in FIG. 33, and “lower” means a lower direction in FIG. 33. In addition, components common to those of the above-described transmission system 1 to 1q are denoted by the same reference numerals, and description thereof will be omitted as appropriate.

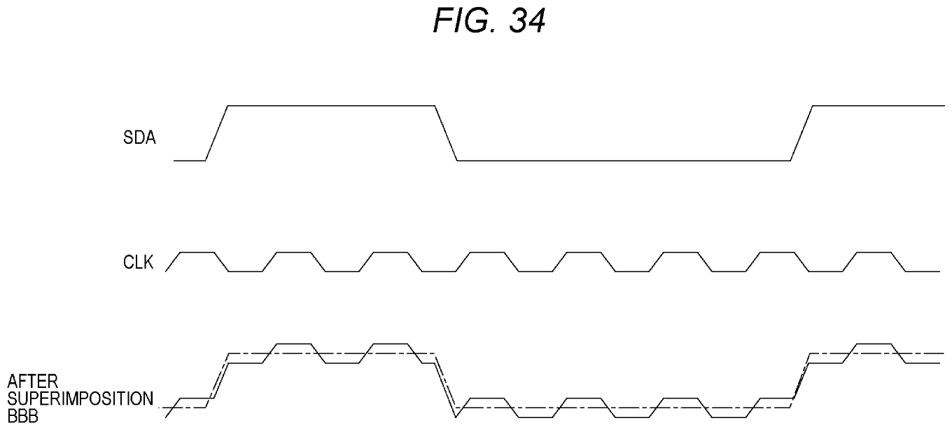

FIG. 34 is a timing chart of the transmission system 1r that is an example of the transmission system according to the eighteenth embodiment of the present technology. FIG. 34 is an explanatory diagram illustrating external data (SDA) transmitted from external apparatus (I2C TX 71), a clock (CLK) of a second transmission circuit (TX_R) 82a of a reception apparatus (reception side block) 12d, and a superimposed signal BBB in which the external data (SDA) and the clock (CLK) are superimposed.

The transmission system 1r according to the eighteenth embodiment of the present technology is a system in which a first transmission circuit (TX_T) 42a, a signal processing unit 21, a second reception circuit (RX_R) 84a, and a signal processing unit 55 are added to the transmission system 1d according to the fifth embodiment of the present technology illustrated in FIG. 6.

As illustrated in FIG. 33, the transmission system 1r according to the eighteenth embodiment of the present technology includes a filter 44a. The transmission system 1r according to the eighteenth embodiment of the present technology superimposes the external data (SDA) of the external apparatus (I2C TX 71) on a clock (CLK) by wired OR. As a result, a transmission apparatus (CIS) 110 receives a single-phase signal in which the external data (SDA) transmitted from the external apparatus (I2C TX 71) and the clock (CLK) transmitted from a reception apparatus (reception LSI) 12o are superimposed.

As described above, the transmission apparatus (CIS) 110 can receive a signal in which the external data (SDA) transmitted from the external apparatus (I2C TX 71) and the clock transmitted from the reception apparatus (reception LSI) 12o are superimposed.

In addition, the transmission apparatus (CIS) 110 includes the filter 44a, and the filter 44a separates the clock (CLK) transmitted from the reception apparatus (reception LSI) 12o from the signal in which the external data (SDA) transmitted from the external apparatus (I2C TX 71) and the clock (CLK) transmitted from the reception apparatus (reception LSI) 12o are superimposed. Further, the filter 44a transmits the separated clock (CLK) to the first reception circuit (clock reception circuit) 41b, and transmits the external data (SDA) to I2CRCV13.

The transmission apparatus (CIS) 110 includes the first transmission circuit (TX_T) 42a, and the first transmission circuit (TX_T) 42a transmits the retention data (DATA) to the reception apparatus (reception LSI) 12o. In the reception apparatus (reception LSI) 12o, the second reception circuit (RX_R) 84a receives the retention data (DATA) transmitted from the first transmission circuit (TX_T) 42a of the transmission apparatus (CIS) 11o.

### 20. Nineteenth Embodiment (Example of Transmission System 19

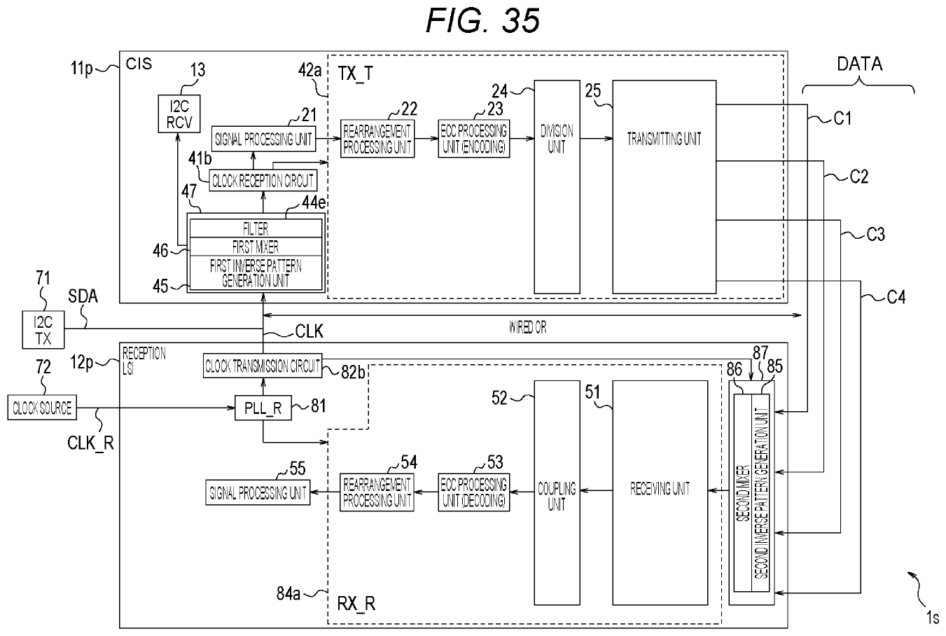

FIG. 35 illustrates a transmission system is that is an example of a transmission system according to a nineteenth embodiment of the present technology. FIG. 35 is a block diagram illustrating a configuration example of a transmission system is to which the present technology is applied. Note that unless otherwise specified, “upper” means an upper direction in FIG. 35, and “lower” means a lower direction in FIG. 35. In addition, components common to those of the above-described transmission system 1 to 1r are denoted by the same reference numerals, and description thereof will be omitted as appropriate.

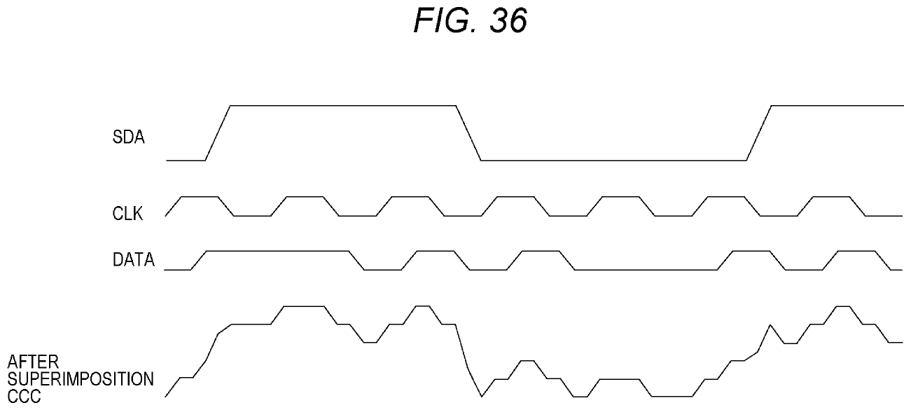

FIG. 36 is a timing chart of the transmission system is that is an example of the transmission system according to the nineteenth embodiment of the present technology. FIG. 36 is an explanatory diagram illustrating external data (SDA) transmitted from an external apparatus (I2C TX 71), a clock (CLK) transmitted from a second transmission circuit (TX_R) 82b of the reception apparatus (reception side block) 12p, retention data (DATA) transmitted from a first transmission circuit (TX_T) 42a of a transmission apparatus (CIS) 11p, and a superimposed signal CCC in which the external data (SDA), the clock (CLK), and the retention data (DATA) are superimposed.

The transmission system is according to the nineteenth embodiment of the present technology is a system in which a first transmission circuit (TX_T) 42a, a signal processing unit 21, a second reception circuit (RX_R) 84a, and a signal processing unit 55 are added to the transmission system 1e according to the sixth embodiment of the present technology illustrated in FIG. 8.

As illustrated in FIG. 35, the transmission system 1s according to the nineteenth embodiment of the present technology further includes a first transmission pattern cancel filter 47 in a transmission apparatus (CIS) 11p and a second transmission pattern cancel filter 87 in a reception apparatus (reception LSI) 12p. In the transmission system 1s according to the nineteenth embodiment of the present technology, in the transmission system 1r according to the eighteenth embodiment, retention data (DATA) transmitted from a first transmission circuit (TX_T) 42a of a transmission apparatus (CIS) 11p is further superimposed on a signal obtained by superimposing a clock (CLK) transmitted from a second transmission circuit (clock transmission circuit) 82b of a reception apparatus (reception LSI) 12p on external data (SDA) transmitted from an external apparatus (I2C TX 71).

The transmission apparatus (CIS) 11p receives a signal CCC in which the external data (SDA) transmitted from the external apparatus (I2C TX 71), the clock (CLK) transmitted from the reception apparatus (reception LSI) 12p, and the retention data (DATA) transmitted from the transmission apparatus (CIS) 11p to the reception apparatus (reception LSI) 12p are superimposed.

In this case, the transmission apparatus (CIS) 11p includes a first transmission pattern cancel filter 47, and the first transmission pattern cancel filter 47 includes a first inverse pattern generation unit 45, a first mixer 46, and a filter 44e. The first inverse pattern generation unit 45 may generate a first inverse pattern having a waveform opposite to a waveform of the retention data (DATA). The first mixer 46 mixes the generated first inverse pattern with a signal CCC in which the external data (SDA) transmitted from the external apparatus (I2C TX 71), the clock (CLK) transmitted from the reception apparatus (reception LSI) 12p, and the retention data (DATA) are superimposed, cancels a waveform of the retention data (DATA) from the signal CCC in which the external data (SDA) transmitted from the external apparatus (I2C TX 71), the clock (CLK) transmitted from the reception apparatus (reception LSI) 12p, and the retention data (DATA) are superimposed to separate the clock (CLK) transmitted from the reception apparatus (reception LSI) 12p and the external data (SDA). In this way, the first mixer 46 can separate the clock (CLK) transmitted from the reception apparatus (reception LSI) 12e and the external data (SDA).

The filter 44e separates the clock (CLK) and the external data (SDA) from the signal in which the clock (CLK) and the external data (SDA) are superimposed. The first transmission pattern cancel filter 47 transmits the external data (SDA) separated by the filter 44e to the I2CRCV13 and transmits the clock (CLK) to the first reception circuit (clock reception circuit) 41b. Note that the filter 44e includes, for example, a frequency filter and a voltage detection filter. For example, in a case where frequency bands of the clock (CLK) and the external data (SDA) are different, the filter 44e can include a frequency filter. In this case, since the frequency bands of the clock (CLK) and the external data (SDA) are different, the filter 44e can separate the clock (CLK) and the external data (SDA) according to the frequency bands.

Further, in a case where the frequency bands of the clock (CLK) and the external data (SDA) are the same, the filter 44e may include a voltage detection filter instead of the frequency filter. In this case, the filter 44e can separate the external data (SDA) from the clock (CLK) by the voltage value detected by the voltage detection filter.

Note that in a case where the first transmission pattern cancel filter 47 can acquire a differential signal of the retention data (DATA), the first mixer 46 may mix the differential signal of the retention data (DATA) with the signal in which the external data (SDA) transmitted from the external apparatus (I2C TX 71), the clock (CLK) transmitted from the reception apparatus (reception LSI) 12e, and the retention data (DATA) are superimposed, cancel the waveform of the retention data (DATA) from the signal in which the external data (SDA) transmitted from the external apparatus (I2C TX 71), the clock (CLK) transmitted from the reception apparatus (reception LSI) 12e, and the retention data (DATA) are superimposed to separate the clock (CLK) transmitted from reception apparatus (reception LSI) 12e and the external data (SDA). In this case, even without the first inverse pattern generation unit 45, the first transmission pattern cancel filter 47 can realize the process of separating the clock (CLK) and the external data (SDA) in an integrated manner.

The reception apparatus (reception LSI) 12p includes a second transmission pattern cancel filter 87, and the second transmission pattern cancel filter 87 includes a second inverse pattern generation unit 85 and a second mixer 86. The second inverse pattern generation unit 85 generates a second inverse pattern having a waveform opposite to a waveform of the external data (SDA) and a third inverse pattern having a waveform opposite to a waveform of the clock (CLK) transmitted from the reception apparatus (reception LSI) 12p. The second mixer 86 mixes the generated waveform of the second inverse pattern and the waveform of the third inverse pattern with the signal CCC in which the external data (SDA) transmitted from the external apparatus (I2C TX 71), the clock (CLK) transmitted from the reception apparatus (reception LSI) 12p, and the retention data (DATA) are superimposed, and cancels the waveform of the external data (SDA) transmitted from the external apparatus (I2C TX 71) and the waveform of the clock (CLK) transmitted from the reception apparatus (reception LSI) 12p from the signal CCC in which the external data (SDA), the clock, and the retention data (DATA) are superimposed to separate the retention data (DATA). In this way, the second transmission pattern cancel filter 87 can separate the retention data (DATA).

Note that in a case where the differential signal of the waveform of the external data (SDA) and the differential signal of the clock transmitted from the reception apparatus (reception LSI) 12 can be acquired, the second transmission pattern cancel filter 87 may mix the differential signal of the waveform of the external data (SDA) and the differential signal of the clock (CLK) transmitted from the reception apparatus (reception LSI) 12e with the signal in which the external data (SDA) transmitted from the external apparatus (I2C TX 71), the clock (CLK) transmitted from the reception apparatus (reception LSI) 12e, and the retention data (DATA) are superimposed, and cancel the waveform of the external data (SDA) and the waveform of the clock (CLK) transmitted from the reception apparatus (reception LSI) 12e from the signal in which the external data (SDA) transmitted from the external apparatus (I2C TX 71), the clock (CLK) transmitted from the reception apparatus (reception LSI) 12e, and the retention data (DATA) are superimposed to separate the retention data (DATA). In this case, even if there is no second inverse pattern generation unit 85, the second transmission pattern cancel filter 87 can realize the process of separating the retention data (DATA) in an integrated manner.

Note that the second transmission pattern cancel filter 87 may include a frequency filter in the case where the frequency bands of the clock (CLK) and the external data (SDA) are different. In the case where the second transmission pattern cancel filter 87 includes, for example, a frequency filter, even if a second inverse pattern having a waveform opposite to a waveform of the external data (SDA) is not generated in the second inverse pattern generation unit 85, since the frequency bands of the clock (CLK) and the external data (SDA) are different, the clock (CLK) and the external data (SDA) can be separated according to the frequency bands.

Further, in the case where the frequency bands of the clock (CLK) and the external data (SDA) are the same, the second transmission pattern cancel filter 87 may include the voltage detection filter instead of the frequency filter. In this case, the second transmission pattern cancel filter 87 can separate the external data (SDA) from the clock (CLK) by the voltage value detected by the voltage detection filter.

Then, the second transmission pattern cancel filter 87 transmits the retention data (DATA) separated by the second mixer 86 to the second reception circuit (RX_R) 84a.

Note that, in the nineteenth embodiment according to the present technology, the external data (SDA) transmitted from the external apparatus (I2C TX 71), the clock (CLK) transmitted from the reception apparatus (reception LSI) 12, and the retention data (DATA) are superimposed; however, at least one of the external data (SDA), the clock (CLK), and the retention data (DATA and DATAB) may be differentiated.

For example, the embodiment in which the retention data (DATA and DATAB) and the clocks (CLK and CLKB) are differentiated is shown as a twentieth embodiment, the embodiment in which the retention data (DATA and DATAB) is differentiated is shown as a twenty-first embodiment, and the embodiment in which the external data (SDA and SDAB), the clocks (CLK and CLKB), and the retention data (DATA and DATAB) are differentiated is shown as the twenty-first embodiment.

### 21. Twentieth Embodiment (Example of Transmission System 20

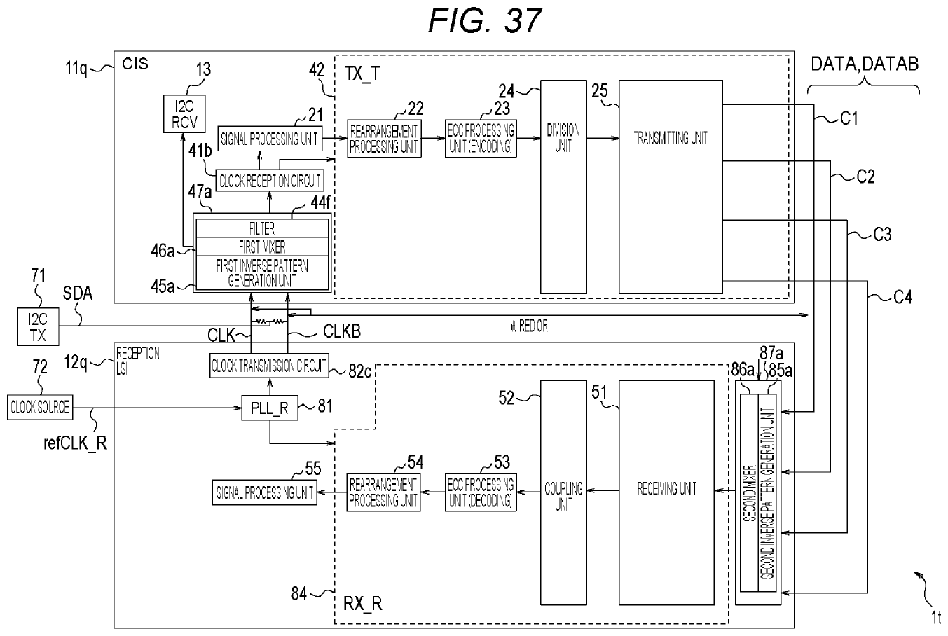

FIG. 37 illustrates a transmission system it that is an example of a transmission system according to a twentieth embodiment of the present technology. FIG. 37 is a block diagram illustrating a configuration example of the transmission system it to which the present technology is applied. Note that unless otherwise specified, “upper” means an upper direction in FIG. 37, and “lower” means a lower direction in FIG. 37. In addition, components common to those of the above-described transmission system 1 to is are denoted by the same reference numerals, and description thereof will be omitted as appropriate.

The transmission system it according to the twentieth embodiment of the present technology is a system in which a first transmission circuit (TX_T) 42, a signal processing unit 21, a second reception circuit (RX_R) 84, and a signal processing unit 55 are added to the transmission system if according to the seventh embodiment of the present technology illustrated in FIG. 10.

As illustrated in FIG. 37, in the transmission system it according to the twentieth embodiment of the present technology, external data (SDA), a clock (CLK), and retention data (DATA and DATAB) are superimposed, similarly to the transmission system is according to the nineteenth embodiment.

The transmission system it of the twentieth embodiment is different from the transmission system is of the nineteenth embodiment in that external data (SDA) of an external apparatus (I2C TX 71) is converted into a single phase, and external data (SDA) is modulated in a common mode on clocks (CLK and CLKB). In addition, the clock (CLK and CLKB) and the retention data (DATA and DATAB) are modulated by wired OR and differentiated.

### 22. Twenty-First Embodiment (Example of Transmission System 21

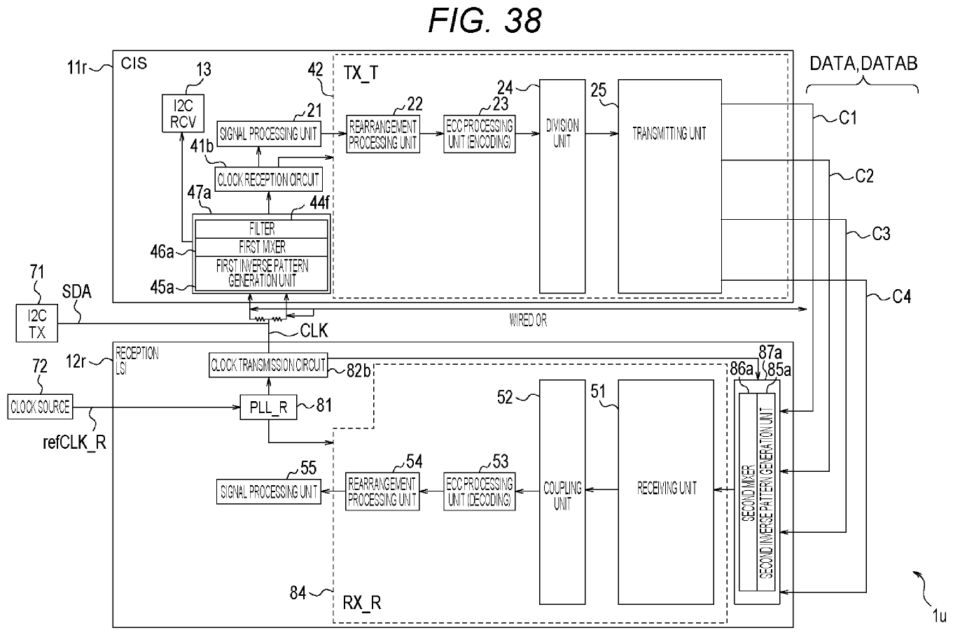

FIG. 38 illustrates a transmission system 1u that is an example of a transmission system according to a twenty-first embodiment of the present technology. FIG. 38 is a block diagram illustrating a configuration example of the transmission system 1u to which the present technology is applied. Note that unless otherwise specified, “upper” means an upper direction in FIG. 38, and “lower” means a lower direction in FIG. 38. In addition, components common to those of the above-described transmission system 1 to it are denoted by the same reference numerals, and description thereof will be omitted as appropriate.

The transmission system 1u according to the twenty-first embodiment of the present technology is a system in which a first transmission circuit (TX_T) 42, a signal processing unit 21, a second reception circuit (RX_R) 84, and a signal processing unit 55 are added to the transmission system 1g according to the eighth embodiment of the present technology illustrated in FIG. 11.

As illustrated in FIG. 38, in the transmission system 1u of the twenty-first embodiment according to the present technology, external data (SDA), a clock (CLK), and retention data (DATA and DATAB) are superimposed, similarly to the transmission system it of the twentieth embodiment.

The transmission system 1u of the twenty-first embodiment is different from the transmission system it of the twentieth embodiment in that external data (SDA) and a clock (CLK) are made into a single phase, and retention data (DATA and DATAB) is differentiated. In this case, the external data (SDA) and the clock (CLK) are modulated by wired OR, and the retention data (DATA and DATAB) is modulated by the common mode on the modulated signal.

### 23. Twenty-Second Embodiment (Example of Transmission System 22

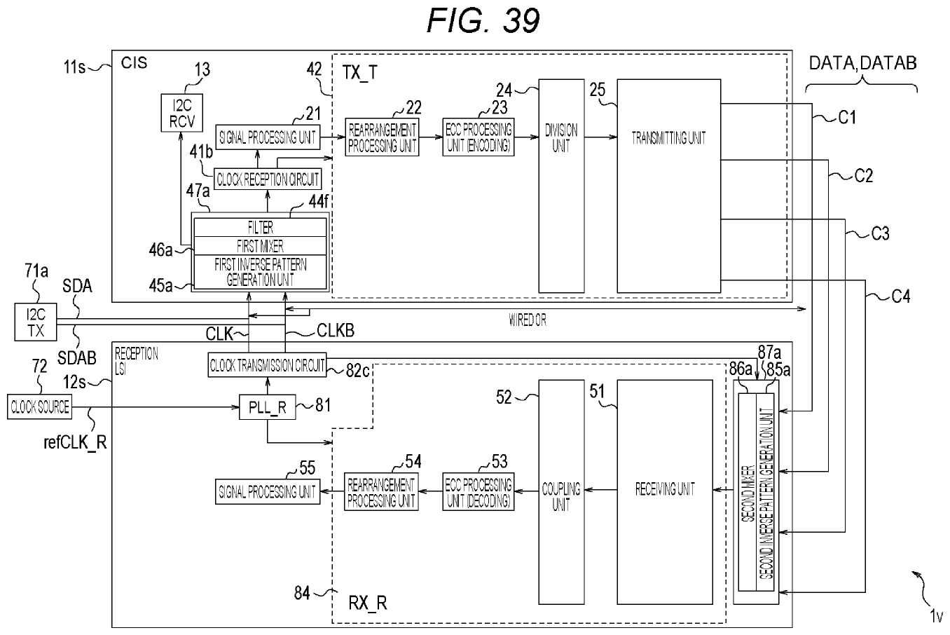

FIG. 39 illustrates a transmission system 1v that is an example of a transmission system according to a twenty-second embodiment of the present technology. FIG. 39 is a block diagram illustrating a configuration example of the transmission system 1v to which the present technology is applied. Note that unless otherwise specified, “upper” means an upper direction in FIG. 39, and “lower” means a lower direction in FIG. 39. In addition, components common to those of the above-described transmission system 1 to 1u are denoted by the same reference numerals, and description thereof will be omitted as appropriate.

The transmission system 1v of the twenty-second embodiment according to the present technology is a system in which a first transmission circuit (TX_T) 42, a signal processing unit 21, a second reception circuit (RX_R) 84, and a signal processing unit 55 are added to the transmission system 1h of the 9 embodiment according to the present technology illustrated in FIG. 12.

As illustrated in FIG. 39, in the transmission system 1v of the twenty-second embodiment according to the present technology, external data (SDA and SDAB), clocks (CLK and CLKB), and retention data (DATA and DATAB) are superimposed.

The transmission system 1v of the twenty-second embodiment is different from the transmission system 1u of the twenty-first embodiment in that all of the external data (SDA and SDAB), the clocks (CLK and CLKB), and the retention data (DATA and DATAB) are differentiated. In this case, the external data (SDA), the clock (CLK), and the retention data (DATA) are modulated by wired OR, and the external data (SDAB), the clock (CLKB), and the retention data (DATAB) are modulated by wired OR.

### 24. Twenty-Third Embodiment (Example of Transmission System 23

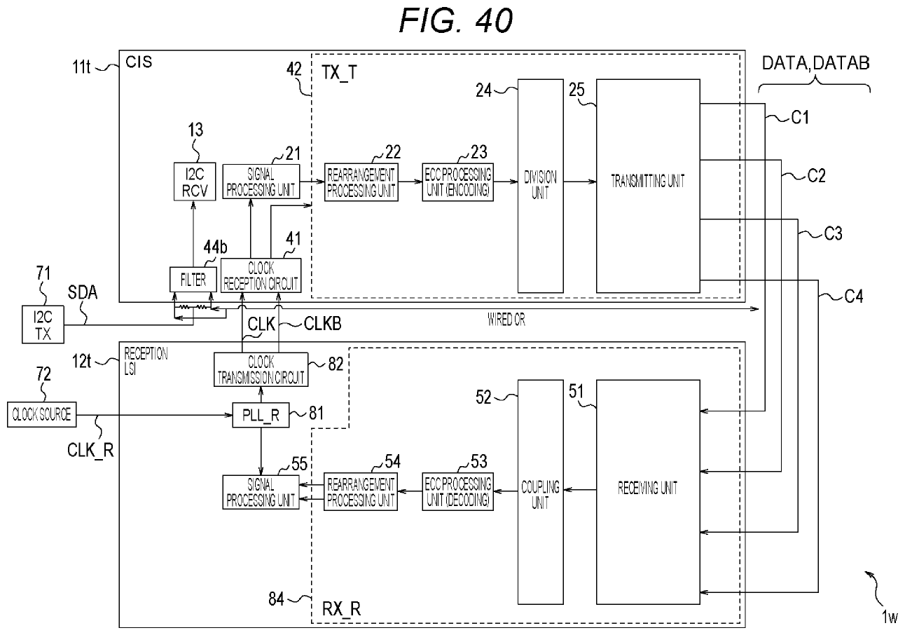

FIG. 40 illustrates a transmission system 1w that is an example of a transmission system according to a twenty-third embodiment of the present technology. FIG. 40 is a block diagram illustrating a configuration example of the transmission system 1w to which the present technology is applied. Note that unless otherwise specified, “upper” means an upper direction in FIG. 40, and “lower” means a lower direction in FIG. 40. In addition, components common to those of the above-described transmission system 1 to 1v are denoted by the same reference numerals, and description thereof will be omitted as appropriate.

The transmission system 1w according to the twenty-third embodiment of the present technology is a system in which a first transmission circuit (TX_T) 42, a signal processing unit 21, a second reception circuit (RX_R) 84, and a signal processing unit 55 are added to the transmission system 1i according to the tenth embodiment of the present technology illustrated in FIG. 13.

As illustrated in FIG. 40, in the transmission system 1w according to the twenty-third embodiment of the present technology, external data (SDA) and retention data (DATA and DATAB) are superimposed, and the external data (SDA) is a single-phase signal. Further, the clocks (CLK and CLKB) and the retention data (DATA and DATAB) transmitted from the reception apparatus (reception LSI) 12t constitute differential signals. Note that the external data (SDA) is configured to apply common mode modulation to the retention data (DATA and DATAB).

The filter 44b separates the external data (SDA) from a signal in which the external data (SDA) transmitted from an external apparatus (I2C TX 71) and the retention data (DATA and DATAB) are superimposed.

### 25. Twenty-Fourth Embodiment (Example of Transmission System 24

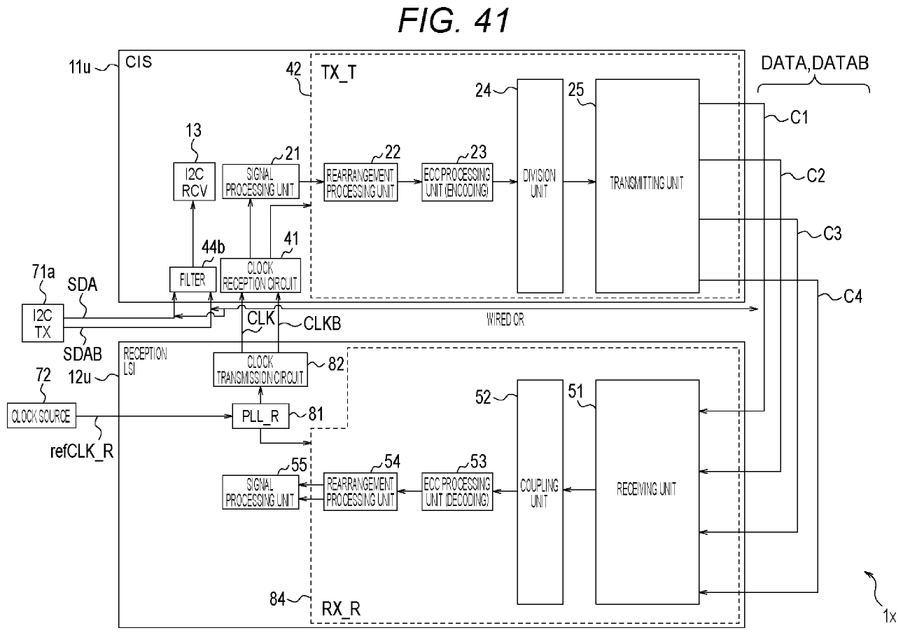

FIG. 41 illustrates a transmission system 1x that is an example of a transmission system according to a twenty-fourth embodiment of the present technology. FIG. 41 is a block diagram illustrating a configuration example of the transmission system 1x to which the present technology is applied. Note that unless otherwise specified, “upper” means an upper direction in FIG. 41, and “lower” means a lower direction in FIG. 41. In addition, components common to those of the above-described transmission system 1 to 1w are denoted by the same reference numerals, and description thereof will be omitted as appropriate.

The transmission system 1x according to the twenty-fourth embodiment of the present technology is a system in which a first transmission circuit (TX_T) 42, a signal processing unit 21, a second reception circuit (RX_R) 84, and a signal processing unit 55 are added to the transmission system 1j according to the eleventh embodiment of the present technology illustrated in FIG. 14.

As illustrated in FIG. 41, in the transmission system 1x according to the twenty-fourth embodiment of the present technology, external data (SDA and SDAB) transmitted from an external apparatus (I2C TX 71a) and retention data (DATA and DATAB) are superimposed. Further, each of the external data (SDA and SDAB), the clocks (CLK and CLKB) transmitted from the reception apparatus (reception LSI) 12u, and the retention data (DATA and DATAB) constitutes a differential signal. The external data (SDA and SDAB) is configured to modulate the retention data (DATA and DATAB) by wired OR.

The filter 44b separates the external data (SDA and SDAB) from a signal in which the external data (SDA and SDAB) transmitted from the external apparatus (I2C TX 71a) and the retention data (DATA and DATAB) are superimposed.

### 26. Twenty-Fifth Embodiment (Example of Transmission System 25

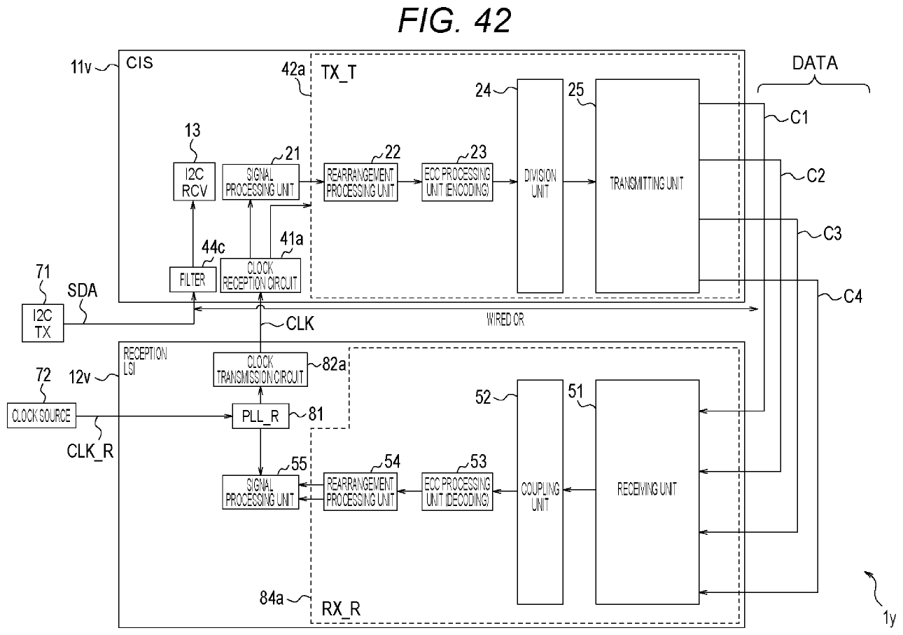

FIG. 42 illustrates a transmission system 1y that is an example of a transmission system according to a twenty-fifth embodiment of the present technology. FIG. 42 is a block diagram illustrating a configuration example of the transmission system 1y to which the present technology is applied. Note that unless otherwise specified, “upper” means an upper direction in FIG. 42, and “lower” means a lower direction in FIG. 42. In addition, components common to those of the above-described transmission system 1 to 1x are denoted by the same reference numerals, and description thereof will be omitted as appropriate.

The transmission system 1y of the twenty-fifth embodiment according to the present technology is a system in which a first transmission circuit (TX_T) 42a, a signal processing unit 21, a second reception circuit (RX_R) 84a, and a signal processing unit 55 are added to the transmission system 1k of the twelfth embodiment according to the present technology illustrated in FIG. 15.

As illustrated in FIG. 42, in the transmission system 1y according to the twenty-fifth embodiment of the present technology, external data (SDA) transmitted from an external apparatus (I2C TX 71) and retention data (DATA) are superimposed. Each of the external data (SDA) and the retention data (DATA) is a single-phase signal. In this case, the external data (SDA) is configured to modulate the retention data (DATA) by wired OR. In the reception apparatus (reception LSI) 12v, the clock (CLK) transmitted from the second transmission circuit (clock transmission circuit) 82a is configured by a single-phase clock, but may be configured by a differential clock.

The filter 44c separates the external data (SDA) from a signal in which the external data (SDA) transmitted from the external apparatus (I2C TX 71) and the retention data (DATA) are superimposed.

Note that the first to twenty-fifth embodiments of the present technology are not limited to the above-described embodiments, and various changes can be made without departing from the gist of the present technology.

For example, in the external data (SDA and SDAB), the retention data (DATA and DATAB), and the clocks (CLK and CLKB), the single-phase signal and the differential signal have been described; however, even if one side of the differential signal is used as a single-phase signal, the differential signal is included in the present technology.

In addition, the reception apparatus (reception LSI) 12 transmits the clocks (CLK and CLKB) from the second transmission circuit (clock transmission circuit) 82 to the transmission apparatus (CIS) 11, but is not limited thereto. For example, the image data processed by the image data processing circuit 120 may be transmitted back, or a control signal used by the projector may be transmitted.

In addition, the effects described in the present specification are merely examples and are not limited, and other effects may be obtained.

In addition, the present technology can have the following configuration.

(1) A transmission apparatus including:

a first reception circuit; and

a first transmission circuit,

in which the first reception circuit receives a clock from the reception apparatus, and

the first transmission circuit synchronizes retention data retained by the first transmission circuit using the received clock, and transmits the retention data to the reception apparatus.

(2) The transmission apparatus described in the (1), further including

an internal circuit,

in which at least one of the first transmission circuit or the internal circuit is driven without changing an operation frequency of the received clock.

(3) The transmission apparatus described in the (1) or (2), in which

the first transmission circuit includes

a first conversion unit,

a correction coding calculation unit,

a division unit, and

a transmitting unit,

the transmitting unit has a plurality of transmission processing units,

the first conversion unit converts the retention data into units constituting a predetermined symbol and outputs each unit,

the correction coding calculation unit calculates an error correction code in the data for each of the plurality of units,

the division unit divides a code word obtained by adding the error correction code to the data of each of the plurality of units into encoded data, and allocates the divided encoded data by a predetermined number so that the plurality of encoded data has the same amount of data in each of a plurality of transmission paths, and

each of the plurality of transmission processing units packetizes the allocated data of the same amount of data and transmits the packetized data to the reception apparatus via the plurality of allocated transmission paths using the received clock.

(4) The transmission apparatus described in the (3), further including

a signal processing unit,

the signal processing unit uses the received clock to perform addition processing on the retention data, and

the first conversion unit converts the data subjected to the addition processing into the units constituting the predetermined symbol.

(5) The transmission apparatus described in any one of the (1) to (4), in which the retention data is image data, or the transmission apparatus further includes an imaging unit, and the retention data is a captured image captured by the imaging unit.

(6) The transmission apparatus described in any one of (1) to (5) in which the first reception circuit receives a single-phase clock or a differential clock, or a signal of either a single-phase signal or a differential signal in which external data transmitted from an external apparatus and a clock transmitted from the reception apparatus are superimposed.

(7) The transmission apparatus described in any one of the (1) to (6), further including

a filter,

in which the filter separates the clock transmitted from the reception apparatus from the signal in which the external data transmitted from the external apparatus and the clock transmitted from the reception apparatus are superimposed.

(8) The transmission apparatus described in any one of the (1) to (7), in which the signal in which the external data transmitted from the external apparatus and the clock transmitted from the reception apparatus are superimposed, or the external data transmitted from the external apparatus, the clock transmitted from the reception apparatus, and the retention data are superimposed.

(9) The transmission apparatus described in any one of the (1) to (8), further including

a first transmission pattern cancel filter,

in which the first transmission pattern cancel filter includes a first mixer, and

the first mixer mixes a differential signal of the retention data with the signal in which the external data transmitted from the external apparatus, the clock transmitted from the reception apparatus, and the retention data are superimposed, cancels a waveform of the retention data from the signal in which the external data transmitted from the external apparatus, the clock transmitted from the reception apparatus, and the retention data are superimposed to separate the clock transmitted from the reception apparatus and the external data.

(10) The transmission apparatus described in any one of the (1) to (8), further including

a first transmission pattern cancel filter,

in which the first transmission pattern cancel filter includes

a first inverse pattern generation unit, and

a first mixer,

the first inverse pattern generation unit generates a first inverse pattern having a waveform opposite to the waveform of the retention data, and

the first mixer mixes the generated waveform of the first inverse pattern with the signal in which the external data transmitted from the external apparatus, the clock transmitted from the reception apparatus, and the retention data are superimposed, cancels a waveform of the retention data from the signal in which the external data transmitted from the external apparatus, the clock transmitted from the reception apparatus, and the retention data are superimposed to separate the clock transmitted from the reception apparatus and the external data.

(11) The transmission apparatus described in any one of the (1) to (10), in which the external data transmitted from the external apparatus, the clock transmitted from the reception apparatus, and the retention data are superimposed, and at least one of the external data, the clock, and the retention data is differentiated.

(12) A transmission apparatus described in any one of the (1) to (11), in which

a single-phase clock is received, and

The external data transmitted from the external apparatus and the retention data are superimposed.

(13) A reception apparatus, including: a second transmission circuit and a second reception circuit,

in which the second transmission circuit transmits a clock to a transmission apparatus, and

the second reception circuit receives retention data retained by the transmission apparatus.

(14) The reception apparatus described in the (13), in which the second transmission circuit transmits a single-phase clock or a differential clock.

(15) The reception apparatus described in the (13) or (14), further including

a second transmission pattern cancel filter,

in which the second transmission pattern cancel filter includes a second mixer, and

the second mixer mixes a differential signal of a waveform of external data and a differential signal of a clock transmitted from the reception apparatus with a signal in which external data transmitted from the external apparatus, a clock transmitted from the reception apparatus, and the retention data are superimposed, and cancels the waveform of the external data and a waveform of the clock of the reception apparatus from the signal in which the external data transmitted from the external apparatus, the clock transmitted from the reception apparatus, and the retention data are superimposed to separate the retention data.

(16) The reception apparatus described in the (13) or (14), further including:

a second transmission pattern cancel filter,

in which the second transmission pattern cancel filter includes

a second inverse pattern generation unit, and

a second mixer,

the second inverse pattern generation unit generates a second inverse pattern having a waveform opposite to the waveform of the external data and a third inverse pattern having a waveform opposite to the waveform of the clock transmitted from the reception apparatus, and

the second mixer mixes the waveform of the second inverse pattern and the waveform of the third inverse pattern with a signal in which external data transmitted from an external apparatus, a clock transmitted from the reception apparatus, and the retention data are superimposed, cancels the waveform of the external data and the waveform of the clock transmitted from the reception apparatus from the signal in which the external data transmitted from the external apparatus, the clock transmitted from the reception apparatus, and the retention data are superimposed to separate the retention data.

(17) The reception apparatus described in any one of the (13) to (16), in which

the second reception circuit includes

a receiving unit,

a coupling unit,

an error correction unit, and

a second conversion unit,

the receiving unit includes a plurality of reception processing units,

the second transmission circuit transmits the clock to the transmission apparatus,

each of the plurality of reception processing units receives packetized data transmitted from the transmission apparatus corresponding to each transmission path,

the coupling unit generates a code word based on encoded data of the plurality of received packetized data,

the error correction unit performs an error correction on an information word based on the error correction code included in the code word, and

the second conversion unit outputs the error-corrected information word as symbol data.

(18) A transmission system, including: a transmission apparatus; and a reception apparatus,

in which the transmission apparatus includes a first reception circuit and a first transmission circuit,

the reception apparatus includes a second transmission circuit and a second reception circuit,

the second transmission circuit transmits a clock to a transmission apparatus,

the first reception circuit receives the clock from the reception apparatus,

the first transmission circuit uses the received clock to transmit retention data retained by the first transmission circuit to the reception apparatus, and

the second reception circuit receives the retention data.

(19) The transmission system described in the (18), in which

the first transmission circuit may include a first conversion unit, a correction coding calculation unit, a division unit, and a transmitting unit,

the transmitting unit may include a plurality of transmission processing units,

the second reception circuit may include a receiving unit, a coupling unit, an error correction unit, and a second conversion unit.

the receiving unit may include a plurality of reception processing units,

when the second transmission circuit may transmit a clock to the transmission apparatus and the first reception circuit may receive the clock from the reception apparatus,

the first conversion unit may convert the retention data into units constituting a predetermined symbol and output each unit,

the correction coding calculation unit may calculate an error correction code in the data for each of the plurality of units,

the division unit may divide a code word obtained by adding the error correction code to the data of each of the plurality of units into encoded data, and allocate the divided encoded data to each of the plurality of transmission paths by a predetermined number so that the plurality of encoded data has the same amount of data in each of a plurality of transmission paths,

each of the plurality of transmission processing units may packetize the allocated data of the same amount of data and transmit the packetized data to the reception apparatus via the plurality of allocated transmission paths using the received clock,

each of the plurality of reception processing units may receive packetized data transmitted from the transmission apparatus corresponding to each of the plurality of transmission paths,

the coupling unit may generate a code word based on encoded data of the plurality of received packetized data,

the error correction unit may perform an error correction on an information word based on the error correction code included in the code word, and

the second conversion unit may output the error-corrected information word as symbol data.

### REFERENCE SIGNS LIST

11 Transmission apparatus (CIS)
12 Reception apparatus (reception LSI)
21 Signal processing unit
22 Rearranging unit
23 ECC processing unit
24 Division unit
25 Transmitting unit
41 First reception circuit (clock reception circuit)
42 First transmission circuit (TX_T)
44, 44a, 44b, 44c Filter
45, 45a First inverse pattern generation unit
46, 46a Mixer
47, 47a First transmission pattern cancel filter
51 Receiving unit
52 Coupling unit
53 ECC processing unit
54 Rearranging unit
55 Signal processing unit
81 PLL_R
82 Second transmission circuit (clock transmission circuit)
85, 85a Second inverse pattern generation unit
86, 86a Mixer
87, 87a Second transmission pattern cancel filter
71 I2C TX

1. A transmission apparatus, comprising:
a first reception circuit; and
a first transmission circuit,
wherein the first reception circuit receives a clock from the reception apparatus, and
the first transmission circuit synchronizes retention data retained by the first transmission circuit using the received clock, and transmits the retention data to the reception apparatus.

2. The transmission apparatus according to claim 1, further comprising:
an internal circuit,
wherein at least one of the first transmission circuit or the internal circuit is driven without changing an operation frequency of the received clock.

3. The transmission apparatus according to claim 1, wherein
the first transmission circuit includes
a first conversion unit,
a correction coding calculation unit,
a division unit, and
a transmitting unit,
wherein the transmitting unit includes a plurality of transmission processing units,
the first conversion unit converts the retention data into units constituting a predetermined symbol and outputs each unit,
the correction coding calculation unit calculates an error correction code in the data for each of the plurality of units,
the division unit divides a code word obtained by adding the error correction code to the data of each of the plurality of units into encoded data, and allocates the divided encoded data by a predetermined number so that the plurality of encoded data has the same amount of data in each of a plurality of transmission paths, and
each of the plurality of transmission processing units packetizes the allocated data of the same amount of data and transmits the packetized data to the reception apparatus via the plurality of allocated transmission paths using the received clock.

4. The transmission apparatus according to claim 3, further comprising:
a signal processing unit,
wherein the signal processing unit uses the received clock to perform addition processing on the retention data, and
the first conversion unit converts the data subjected to the addition processing into the units constituting the predetermined symbol.

5. The transmission apparatus according to claim 1, wherein the retention data is image data, or the transmission apparatus further includes an imaging unit, and the retention data is a captured image captured by the imaging unit.

6. The transmission apparatus according to claim 1, wherein the first reception circuit receives a single-phase clock or a differential clock, or a signal of either a single-phase signal or a differential signal in which external data transmitted from an external apparatus and a clock transmitted from the reception apparatus are superimposed.

7. The transmission apparatus according to claim 1, further comprising:
a filter,
wherein the filter separates a clock transmitted from the reception apparatus from a signal in which external data transmitted from an external apparatus and a clock transmitted from the reception apparatus are superimposed.

8. The transmission apparatus according to claim 1, wherein a signal in which external data transmitted from an external apparatus and a clock transmitted from the reception apparatus are superimposed, or external data transmitted from the external apparatus, a clock transmitted from the reception apparatus, and the retention data are superimposed.

9. The transmission apparatus according to claim 1, further comprising:
a first transmission pattern cancel filter,
wherein the first transmission pattern cancel filter includes a first mixer, and
the first mixer mixes a differential signal of the retention data with a signal in which external data transmitted from an external apparatus, a clock transmitted from the reception apparatus, and the retention data are superimposed, cancels a waveform of the retention data from the signal in which the external data transmitted from the external apparatus, the clock transmitted from the reception apparatus, and the retention data are superimposed to separate the clock transmitted from the reception apparatus and the external data.

10. The transmission apparatus according to claim 1, further comprising:
a first transmission pattern cancel filter,
wherein the first transmission pattern cancel filter includes
a first inverse pattern generation unit, and
a first mixer,
the first inverse pattern generation unit generates a first inverse pattern having a waveform opposite to a waveform of the retention data, and
the first mixer mixes the generated waveform of the first inverse pattern with a signal in which external data transmitted from an external apparatus, a clock transmitted from the reception apparatus, and the retention data are superimposed, cancels a waveform of the retention data from the signal in which the external data transmitted from the external apparatus, the clock transmitted from the reception apparatus, and the retention data are superimposed to separate the clock transmitted from the reception apparatus and the external data.

11. The transmission apparatus according to claim 1, wherein external data transmitted from an external apparatus, a clock transmitted from the reception apparatus, and the retention data are superimposed, and at least one of the external data, the clock, and the retention data is differentiated.

12. The transmission apparatus according to claim 1, wherein
a single-phase clock is received, and
external data transmitted from an external apparatus and the retention data are superimposed.

13. A reception apparatus, comprising: a second transmission circuit; and a second reception circuit,
wherein the second transmission circuit transmits a clock to a transmission apparatus, and
the second reception circuit receives retention data retained by the transmission apparatus.

14. The reception apparatus according to claim 13, wherein the second transmission circuit transmits a single-phase clock or a differential clock.

15. The reception apparatus according to claim 13, further comprising:
a second transmission pattern cancel filter,
wherein the second transmission pattern cancel filter includes a second mixer, and
the second mixer mixes a differential signal of a waveform of external data and a differential signal of a clock transmitted from the reception apparatus with a signal in which external data transmitted from the external apparatus, a clock transmitted from the reception apparatus, and the retention data are superimposed, and cancels the waveform of the external data and a waveform of the clock of the reception apparatus from the signal in which the external data transmitted from the external apparatus, the clock transmitted from the reception apparatus, and the retention data are superimposed to separate the retention data.

16. The reception apparatus according to claim 13, further comprising:
a second transmission pattern cancel filter,
wherein the second transmission pattern cancel filter includes
a second inverse pattern generation unit, and
a second mixer,
the second inverse pattern generation unit generates a second inverse pattern having a waveform opposite to the waveform of the external data and a third inverse pattern having a waveform opposite to the waveform of the clock transmitted from the reception apparatus, and
the second mixer mixes the waveform of the second inverse pattern and the waveform of the third inverse pattern with a signal in which external data transmitted from an external apparatus, a clock transmitted from the reception apparatus, and the retention data are superimposed, cancels the waveform of the external data and the waveform of the clock transmitted from the reception apparatus from the signal in which the external data transmitted from the external apparatus, the clock transmitted from the reception apparatus, and the retention data are superimposed to separate the retention data.

17. The reception apparatus according to claim 13, wherein
the second reception circuit includes
a receiving unit,
a coupling unit,
an error correction unit, and
a second conversion unit,
wherein the receiving unit includes a plurality of reception processing units,
the second transmission circuit transmits the clock to the transmission apparatus,
each of the plurality of reception processing units receives packetized data transmitted from the transmission apparatus corresponding to each transmission path,
the coupling unit generates a code word based on encoded data of the plurality of received packetized data,
the error correction unit performs an error correction on an information word based on the error correction code included in the code word, and
the second conversion unit outputs the error-corrected information word as symbol data.

18. A transmission system comprising: a transmission apparatus; and a reception apparatus,
wherein the transmission apparatus includes a first reception circuit and a first transmission circuit,
the reception apparatus includes a second transmission circuit and a second reception circuit,
the second transmission circuit transmits a clock to a transmission apparatus,
the first reception circuit receives the clock from the reception apparatus,
the first transmission circuit uses the received clock to transmit retention data retained by the first transmission circuit to the reception apparatus, and
the second reception circuit receives the retention data.

19. The transmission system according to claim 18, wherein
the first transmission circuit includes a first conversion unit, a correction coding calculation unit, a division unit, and a transmitting unit,
the transmitting unit includes a plurality of transmission processing units,
the second reception circuit includes a receiving unit, a coupling unit, an error correction unit, and a second conversion unit,
the receiving unit includes a plurality of reception processing units,
when the second transmission circuit transmits a clock to the transmission apparatus and the first reception circuit receives the clock from the reception apparatus,
the first conversion unit converts the retention data into units constituting a predetermined symbol and outputs each unit,
the correction coding calculation unit calculates an error correction code in the data for each of the plurality of units,
the division unit divides a code word obtained by adding the error correction code to the data of each of the plurality of units into encoded data, and allocates the divided encoded data to each of the plurality of transmission paths by a predetermined number so that the plurality of encoded data has the same amount of data in each of a plurality of transmission paths,
each of the plurality of transmission processing units packetizes the allocated data of the same amount of data and transmits the packetized data to the reception apparatus via the plurality of allocated transmission paths using the received clock,
each of the plurality of reception processing units receives packetized data transmitted from the transmission apparatus corresponding to each of the plurality of transmission paths,
the coupling unit generates a code word based on encoded data of the plurality of received packetized data,
the error correction unit performs an error correction on an information word based on the error correction code included in the code word, and
the second conversion unit outputs the error-corrected information word as symbol data.
